(19) United States
(12) Patent Application Publication
(10) Pub. No.: US 2025/0157144 A1
(43) Pub. Date: May 15, 2025

(54) POINT CLOUD DATA DISPLAY APPARATUS, POINT CLOUD DATA STORAGE APPARATUS, POINT CLOUD DATA DISPLAY METHOD, AND POINT CLOUD DATA DISPLAY PROGRAM

(71) Applicant: Nippon Telegraph and Telephone Corporation, Tokyo (JP)

(72) Inventors: Takahiro MATSUMOTO, Musashino-shi, Tokyo (JP); Xiaojun WU, Musashino-shi, Tokyo (JP); Masahiko TSUJI, Musashino-shi, Tokyo (JP)

(21) Appl. No.: 18/839,467

(22) PCT Filed: Mar. 7, 2022
(86) PCT No.: PCT/JP2022/009612

§ 371 Date: Aug. 19, 2024

(51) Int. Cl. G06T 17/00; G06F 3/01

(52) U.S. Cl. CPC G06T 17/00; G06F 3/013

(57) ABSTRACT

To enable large-scale three-dimensional (3D) point cloud data on a point cloud data distribution server to be downloaded and displayed at high speed. A point cloud data display device includes storage areas of layers, a storage control unit, and a display unit. The storage areas of layers store 3D point cloud data measured for each of a plurality of continuous unit spaces such that 3D point cloud data included in a lower layer is included in an upper layer. The storage control unit acquires minimum necessary 3D point cloud data to be stored in a storage area of each layer, and causes the minimum necessary 3D point cloud data to be stored. The display unit reads the 3D point cloud data stored in a storage area of a highest layer among the storage areas of layers, and displays the 3D point cloud data in a 3D virtual reality space.

### TECHNICAL FIELD

An aspect of the present invention relates to a point cloud data display device, a point cloud data storage device, a point cloud data display method, and a point cloud data display program.

### BACKGROUND ART

In recent years, in a three-dimensional (3D) virtual reality (VR) space expressed in a point cloud format, viewing of the space from a first person's viewpoint or movement in the 3D VR space is about to be performed through a viewing terminal. As the viewing terminal, a personal computer (PC), a smartphone, a head mounted display (HMD), or the like is assumed to be used. Viewing of 3D point cloud data on such a viewing terminal has attracted attention as a new spatial expression method that can give a different experience from a 3D space expressed by polygons or the like so far.

As a method of causing a large number of users to view such 3D point cloud data, for example, server-client type data distribution can be considered. That is, the 3D point cloud data is arranged on a point cloud data distribution server, and the viewing terminal is used as a client terminal, and the 3D point cloud data is downloaded from the point cloud data distribution server to the viewing terminal via a network such as the Internet.

In a case where the 3D VR space expressed by the point cloud is presented to the user, if arrangement density in spatial resolution of a point cloud becomes low, a space between points becomes too large, and reality in spatial expression decreases. On the other hand, when it is attempted to express a 3D VR space in a certain range by spatially high-resolution fine 3D point cloud data, it is not rare that the number of points required for spatial expression is hundreds of millions to several tens of billions, and a total amount of data becomes an enormous amount of information of several GB to several TB.

As described above, when the number of points increases, that is, the amount of data increases, the following three problems occur in a viewing form in which large-scale 3D point cloud data on the point cloud data distribution server is viewed through the viewing terminal.

A first problem is that, when it is attempted to draw a large number of points as a 3D VR space at a time on the viewing terminal, graphics performance of a graphics processing unit (GPU) or the like included in the viewing terminal is exceeded, and a drawing frame rate cannot be secured that is fit for viewing. In general, the drawing frame rate required to provide a comfortable VR experience is said to be 120 fps. With a point cloud data display device having poor graphics performance, it is difficult to continue drawing a large amount of 3D point cloud data at a high frame rate such as 120 fps according to the viewing position/angle in the 3D VR space in terms of an amount of calculation processing.

A second problem is that, when it is attempted to store a large amount of data in the point cloud data display device at a time, a data area such as a memory or a storage in which data can be held by the viewing terminal is exceeded.

A third problem is that, when it is attempted to download the large-scale 3D point cloud data on the point cloud data distribution server from the server to the client terminal via the network, the amount of data is large, and thus it takes time until the download is completed to the viewing terminal that is the client terminal.

To solve such problems, various proposals have been made.

For example, Non Patent Literature 1 proposes a method of reducing the number of points to be drawn at a time by searching for neighboring points of a 3D VR space in directions in 360 degrees from a viewpoint position in the 3D VR space and deleting points other than the nearest points when the 3D VR space is viewed with an HMD.

In addition, Non Patent Literature 2 proposes a method of viewing a large-scale 3D VR space via a web browser. The method proposed by Non Patent Literature 2 is to store a 3D VR space in a state where the 3D VR space can be expressed by a plurality of point cloud densities (levels of detail (LoD)), refer to a high-density point cloud in an area that falls within a viewing angle of the viewpoint and is near the viewpoint position, and refer to a low-density point cloud in an area that falls within the viewing angle of the viewpoint and is in the distance. As a result, it is implemented that the number of points to be simultaneously drawn at a time is reduced, and an amount of calculation is reduced that is the first problem. In addition, in the present method, the number of points to be read is managed to be less than or equal to a certain number, and unnecessary points are discarded, whereby the second problem is also solved.

### CITATION LIST

### Non Patent Literature

Non Patent Literature 1: Hiroshi Ishibashi, Kazuto Saito, and Hiroshi Masuda, Efficient Point-Based Stereoscopic Rendering for Supporting Maintenance Tasks, Proceedings of the Japan Society for Precision Engineering, Vol. 2017, 2017A, 2017 the Japan Society for Precision Engineering Autumn meeting, Session ID H21, p. 535-536 Non Patent Literature 2: Schutz, Markus. “Potree: Rendering large point clouds in web browsers.” Diss. Wien, 2015.

### SUMMARY OF INVENTION

### Technical Problem

Although the method proposed by Non Patent Literature 1 can reduce the amount of calculation that is the first problem, in a case where the viewpoint position is moved, it is necessary to re-search for the nearest point every time the viewpoint position is moved, and thus, it is difficult to apply the method in a condition where the viewpoint position is frequently moved. In addition, this method is based on the premise that all of the 3D point cloud data is stored in the local storage of the client terminal, and Non Patent Literature 1 does not describe the solutions to the second and third problems.

In the method proposed by Non Patent Literature 2, regarding the third problem, when a position or a direction of the viewpoint in the 3D VR space is changed, it is necessary to reread the point cloud from the server via the network according to the position or the direction of the viewpoint. For that reason, in this method, there remains a problem that drawing is made with a low-density point cloud even though the point cloud is the neighboring point of the visual field until the reading of the 3D point cloud data is ended, and there has been room for improvement.

The present invention has been made in view of the above circumstances, and an object of the present invention is to provide a point cloud data display device, a point cloud data storage device, a point cloud data display method, and a point cloud data display program that enables that large-scale 3D point cloud data on a point cloud data distribution server is downloaded and displayed at high speed by a viewing terminal that is a client terminal.

### Solution to Problem

To solve the above problem, a point cloud data display device according to an aspect of the present invention includes storage areas of a plurality of layers, a storage control unit, and a display unit. The storage areas of the plurality of layers hierarchically store 3D point cloud data measured for each of a plurality of continuous unit spaces such that 3D point cloud data included in a lower layer is included in an upper layer. The storage control unit acquires, for each of the storage areas of the plurality of layers, minimum necessary 3D point cloud data to be stored in a storage area of each layer from a storage area of a layer one layer lower, and causes the minimum necessary 3D point cloud data to be stored. The display unit reads the 3D point cloud data stored in a storage area of a highest layer among the storage areas of the plurality of layers according to a viewpoint position and a line-of-sight direction of a user, and displays the 3D point cloud data in a 3D virtual reality space.

### Advantageous Effects of Invention

According to an aspect of the present invention, it is possible to provide a point cloud data display device, a point cloud data storage device, a point cloud data display method, and a point cloud data display program that enables reduction of restrictions on graphics processing capability of a viewing terminal that is a client terminal, and influence of a data acquisition time due to a band and a delay of a network, and enables that large-scale 3D point cloud data on a point cloud data distribution server is downloaded and displayed at high speed by a viewing terminal, by having a multi-stage storage area configuration and selecting and reading point cloud information necessary for a natural drawing for a user on the basis of a viewpoint position and a line-of-sight direction.

### BRIEF DESCRIPTION OF DRAWINGS

FIG. 1 is a schematic diagram illustrating an example of a point cloud data display device according to a first embodiment of the present invention.

FIG. 2 is a block diagram illustrating an example of a hardware configuration of a viewing terminal in the point cloud data display device.

FIG. 3 is a block diagram illustrating functional configurations of the viewing terminal and a point cloud data distribution server in the point cloud data display device.

FIG. 4A is a diagram illustrating a first portion of a block diagram illustrating a flow of information in the functional configurations of the viewing terminal and the point cloud data distribution server.

FIG. 4B is a diagram illustrating a second portion of the block diagram illustrating the flow of the information in the functional configurations of the viewing terminal and the point cloud data distribution server.

FIG. 5 is a schematic diagram for explaining a point cloud density in a cubic space in storage areas of three layers.

FIG. 6 is a schematic diagram illustrating a 3D VR space represented by the cubic space of FIG. 5.

FIG. 7 is a schematic diagram for explaining a position and a direction of a viewpoint in the 3D VR space.

FIG. 8 is a schematic diagram for explaining a method of displaying a point cloud of the 3D VR space on the viewing terminal.

FIG. 9 is a schematic diagram illustrating a relationship between a storage range and a storage location of a point cloud in the storage areas of three layers, and a viewpoint position and a line-of-sight direction in the 3D VR space.

FIG. 10 is a schematic diagram for explaining update of point cloud information in a data memory of the viewing terminal in a case where the viewpoint position and/or the line-of-sight direction in the 3D VR space is moved.

FIG. 11 is a schematic diagram for explaining update of point cloud information in a data storage of the viewing terminal in a case where the viewpoint position and/or the line-of-sight direction in the 3D VR space is moved.

FIG. 12 is a schematic diagram for explaining an example of a storage format of a position and a center direction of a user viewpoint in world coordinates in an in-space position/direction DB of the viewing terminal.

FIG. 13 is a schematic diagram for explaining an example of a storage format of an array list in a local memory point cloud requester of the viewing terminal.

FIG. 14 is a schematic diagram for explaining an example of a storage format of information regarding each of cubic spaces in a local memory point cloud map of the viewing terminal.

FIG. 15 is a schematic diagram for explaining an example of a storage format of association of the viewpoint position and the line-of-sight direction on a local memory read area map of the viewing terminal with the cubic space and LoD to be acquired.

FIG. 16 is a flowchart illustrating an example of an operation processing procedure by a point cloud rendering processing unit of the viewing terminal.

FIG. 17 is a schematic diagram for explaining coordinate transformation of points arranged in the 3D VR space into a screen coordinate system corresponding to the viewpoint position and the line-of-sight direction in the 3D VR space.

FIG. 18 is a flowchart illustrating an example of an operation processing procedure by a local memory position monitoring processing unit of the viewing terminal.

FIG. 19 is a flowchart illustrating an example of an operation processing procedure by a local memory map update processing unit of the viewing terminal.

FIG. 20 is a flowchart illustrating an example of an operation processing procedure by a local storage position monitoring processing unit of the viewing terminal.

FIG. 21 is a flowchart illustrating an example of an operation processing procedure by a local storage map update processing unit of the viewing terminal.

FIG. 22 is a flowchart illustrating an example of an operation processing procedure by a server point cloud data distribution processing unit of the point cloud data distribution server.

FIG. 23 is a block diagram illustrating a configuration example of the viewing terminal in a point cloud data display device according to a second embodiment of the present invention.

FIG. 24 is a block diagram illustrating a configuration example of the viewing terminal and the point cloud data distribution server in a point cloud data display device according to a third embodiment of the present invention.

### DESCRIPTION OF EMBODIMENTS

### First Embodiment

Hereinafter, a first embodiment according to the present invention will be described with reference to the drawings.

### (Configuration Example)

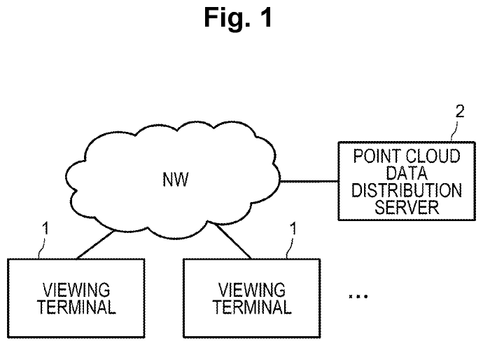

FIG. 1 is a schematic diagram illustrating an example of a point cloud data display device according to the first embodiment of the present invention. In the point cloud data display device, a large number of viewing terminals 1 and a point cloud data distribution server 2 are connected to each other via a network NW such as the Internet.

The point cloud data distribution server 2 is a server computer that holds 3D point cloud data to be distributed to a large number of users, and has a storage area capable of holding all of the 3D point cloud data. The 3D point cloud data is acquired by scanning a target facility to be displayed in a 3D VR space with a laser scanner or the like. In the present embodiment, a method of acquiring the 3D point cloud data and a method of transferring the acquired 3D point cloud data to the point cloud data distribution server 2 are not limited at all.

Each viewing terminal 1 is a client terminal that downloads and displays the 3D point cloud data from the point cloud data distribution server 2.

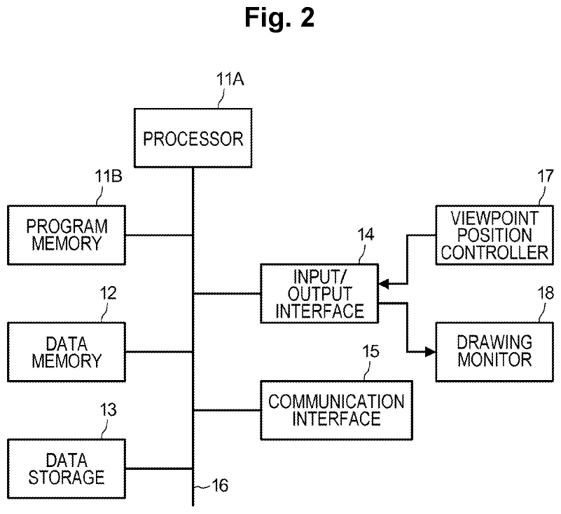

FIG. 2 is a block diagram illustrating an example of a hardware configuration of the viewing terminal 1. The viewing terminal 1 is implemented by a computer such as a PC, a smartphone, or an HMD. The viewing terminal 1 includes, for example, a processor 11A such as a central processing unit (CPU). The processor 11A may be a multi-core/multi-thread processor and can execute a plurality of pieces of processing in parallel. Then, the viewing terminal 1 is configured such that a program memory 11B, a data memory 12, a data storage 13, an input/output interface 14, and a communication interface 15 are connected to the processor 11A via a bus 16.

The program memory 11B uses, as a storage medium, for example, a combination of a non-volatile memory capable of writing and reading at any time, such as a hard disk drive (HDD) or a solid state drive (SSD), and a non-volatile memory such as a read only memory (ROM). The program memory 11B stores programs necessary for the processor 11A to execute various types of processing. The programs include an operating system (OS) and various application programs, and includes a point cloud data display program according to the first embodiment as one of the application programs.

The data memory 12 is a general-purpose memory or a memory area capable of holding data for graphics processing. The data memory 12 uses, for example, a volatile memory such as a random access memory (RAM) as a storage medium.

The data storage 13 is a storage area capable of holding data. The data storage 13 uses, as a storage medium, for example, a non-volatile memory capable of writing and reading at any time, such as an HDD or an SSD. The data storage 13 is used to store the 3D point cloud data downloaded from the point cloud data distribution server 2.

The input/output interface 14 is an interface with a viewpoint position controller 17 as an input device and a drawing monitor 18 as an output device.

The viewpoint position controller 17 is a controller with which a user viewing the 3D VR space in a point cloud expression controls a viewpoint position and a line-of-sight direction in the 3D VR space. Specifically, the viewpoint position controller 17 corresponds to an arrow key of a keyboard or a pointing device such as a mouse in a case where the viewing terminal 1 is a PC, operation buttons arranged on a screen in a case where the viewing terminal 1 is a smartphone, a terminal direction acquired by a sensor inside an HMD or a controller for the HMD in a case where the viewing terminal 1 is the HMD, or the like.

The drawing monitor 18 is a display device that presents 3D VR space information to the user through a screen.

The communication interface 15 is a wired or wireless communication unit for connecting to the network NW.

Note that, although not particularly illustrated, the point cloud data distribution server 2 can also have a hardware configuration similar to that of the viewing terminal 1 illustrated in FIG. 2. However, the input device connected to the input/output interface is a keyboard or a pointing device. Further, the input device can include a reader for reading a file or data to be stored in the data memory from a memory medium such as a USB memory, and a disk device for reading such a file or data from a disk medium. The output device connected to the input/output interface can include a display that displays output data from the processor, a printer that prints the output data, and the like.

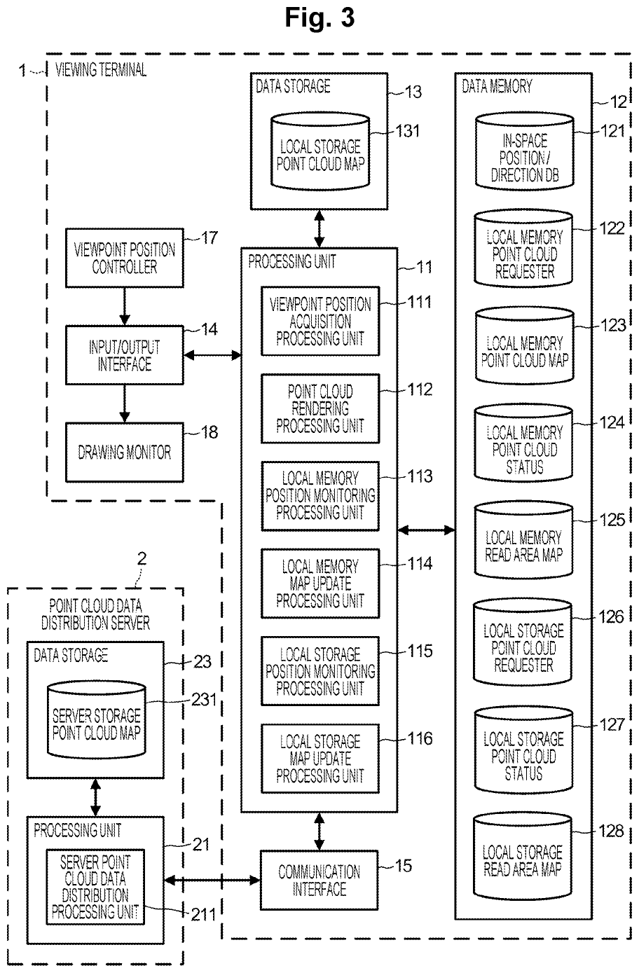

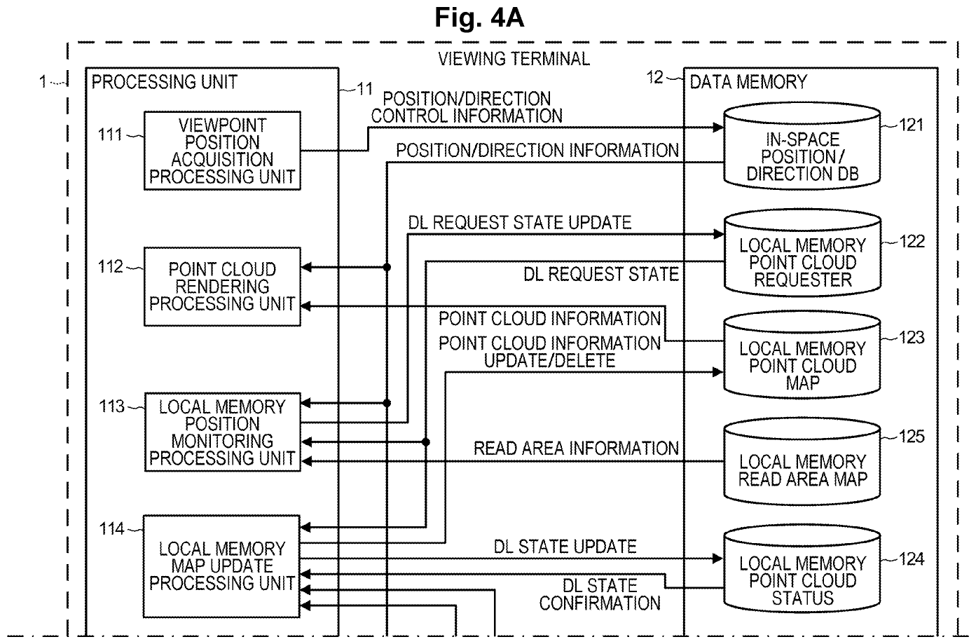

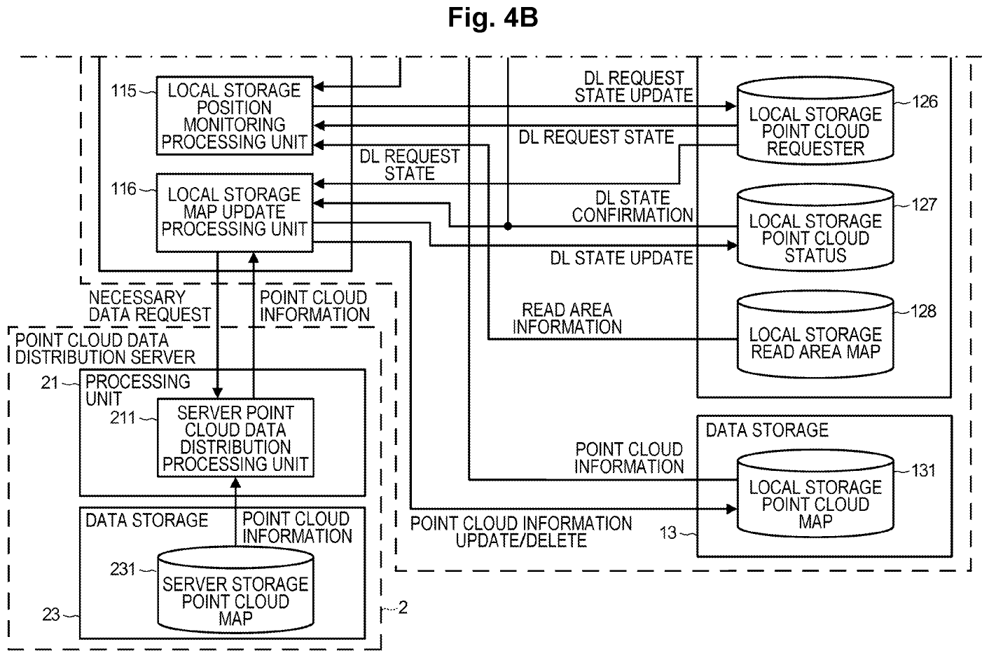

FIG. 3 is a block diagram illustrating functional configurations of the viewing terminal 1 and the point cloud data distribution server 2 in association with the hardware configuration illustrated in FIG. 2. In addition, FIGS. 4A and 4B are block diagrams illustrating a flow of information in the functional configurations of the viewing terminal 1 and the point cloud data distribution server 2. Note that, in the present embodiment, a description will be given of an example of storage areas of three layers of a server, a local storage, and a local memory.

A processing unit 11 of the viewing terminal 1 includes the processor 11A and the program memory 11B, and includes, as processing function units by software for viewing of large-scale 3D space point cloud data on the point cloud data distribution server 2 in VR, a viewpoint position acquisition processing unit 111, a point cloud rendering processing unit 112, a local memory position monitoring processing unit 113, a local memory map update processing unit 114, a local storage position monitoring processing unit 115, and a local storage map update processing unit 116. These processing units are implemented by causing the processor 11A to execute the point cloud data display program stored in the program memory 11B. The processing unit 11 may also be implemented in a form of various other hardware circuits including an integrated circuit such as an application specific integrated circuit (ASIC), a digital signal processor (DSP), a field-programmable gate array (FPGA), or a GPU

In addition, a storage area of the data memory 12 of the viewing terminal 1 includes an in-space position/direction database (Hereinafter, it is abbreviated as DB.) 121, a local memory point cloud requester 122, a local memory point cloud map 123, a local memory point cloud status 124, a local memory read area map 125, a local storage point cloud requester 126, a local storage point cloud status 127, and a local storage read area map 128.

In addition, the data storage 13 of the viewing terminal 1 includes a local storage point cloud map 131.

Meanwhile, a processing unit 21 of the point cloud data distribution server 2 also includes a processor and a program memory, and includes a server point cloud data distribution processing unit 211 as a processing function unit by software. The server point cloud data distribution processing unit 211 is implemented by causing the processor to execute a point cloud data distribution program stored in the program memory. The processing unit 21 of the point cloud data distribution server 2 may also be implemented in the form of various other hardware circuits including an integrated circuit such as an application specific integrated circuit (ASIC), a digital signal processor (DSP), a field-programmable gate array (FPGA), or a GPU. A storage area of a data storage 23 of the point cloud data distribution server 2 includes a server storage point cloud map 231.

Before describing each unit of the functional configurations of the viewing terminal 1 and the point cloud data distribution server 2, the 3D point cloud data will be described. The 3D point cloud data is point cloud information expressed by a data structure capable of expressing a plurality of pieces of point information existing in one 3D VR space with a plurality of densities.

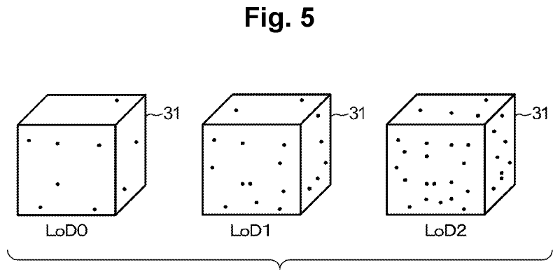

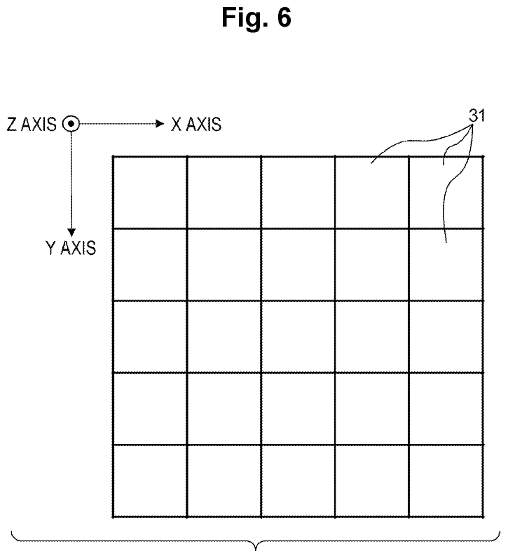

Here, a description will be given of an example of the data structure capable of expressing a plurality of pieces of point information existing in one 3D VR space with a plurality of densities. FIG. 5 is a schematic diagram for explaining a point cloud density in a cubic space in the storage areas of three layers. In addition, FIG. 6 is a schematic diagram illustrating a 3D VR space represented by the cubic space of FIG. 5.

FIG. 5 illustrates three cubic spaces 31 having different point cloud densities (LoD) when a cubic space 31 having a certain size on one side is assumed as a unit space. Here, the point cloud densities are LoD2>LoD1>LoD0. The cubic space 31 of LoD2 having the highest point cloud density includes an entire point cloud existing in the cubic space 31. The cubic space 31 of LoD1 having the next highest point cloud density includes point cloud information obtained by thinning out point cloud information from point cloud information with Lod2 at a certain rate. The cubic space 31 of LoD0 having the lowest point cloud density includes point cloud information obtained by thinning out point cloud information from point cloud information with Lod1 at a certain rate.

As illustrated in FIG. 6, by arranging the cubic spaces 31 of LoD2, LoD1, and LoD0 in the X, Y, and Z axis directions of a three-dimensional box space, it is possible to express a 3D VR space of any size and point cloud information included in the 3D VR space with a plurality of point cloud densities (three densities in a case of LoD2, LoD1, and LoD0). Hereinafter, an area that can be expressed by three axes of X, Y, and Z in which the cubic spaces 31 including the point cloud illustrated in FIG. 6 are arranged, is expressed as three-dimensional box space coordinates. The cubic space 31 existing in the three-dimensional box space coordinates can uniquely indicate a position in the three-dimensional box space with integer values of X, Y, and Z.

Note that the data structure capable of expressing a plurality of pieces of point information existing in the 3D VR space with a plurality of densities corresponds to, in addition to a data structure illustrated in FIGS. 5 and 6, an Octree-based MPEG Geometry-based PCC standardized by Motion Picture Experts Group (MPEG), which is a group studying international standardization of moving images and the like, a Potree format proposed in Non Patent Literature 2, and the like.

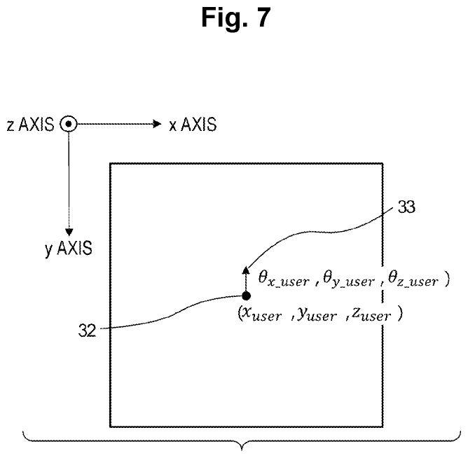

FIG. 7 is a schematic diagram for explaining a position and a direction of a viewpoint in the 3D VR space. In the present embodiment, it is assumed that there are a viewpoint position 32 and a line-of-sight direction 33 from one point in the 3D VR space. For example, as illustrated in FIG. 7, the viewpoint position 32 and the line-of-sight direction 33 can be defined by coordinate points xᵤₛₑᵣ, yᵤₛₑᵣ, and zᵤₛₑᵣ and Euler angles θ_{x_user}, θ_{y_user}, and θ_{z_user} on the 3D VR space. Note that coordinate values of x, y, and z in the 3D VR space in this case can take real values. In addition, as a method of expressing the viewpoint position 32 and the line-of-sight direction 33, a method using polar coordinates, a method using quaternions, or the like may be used. Note that, in the present embodiment, control of the position and/or direction of the viewpoint in the 3D VR space indicates that the user controls the coordinates and/or the line-of-sight direction through the viewpoint position controller 17 such as a mouse of a PC, a position/direction measuring device of an HMD, a software button of a smartphone, a built-in sensor, or the like.

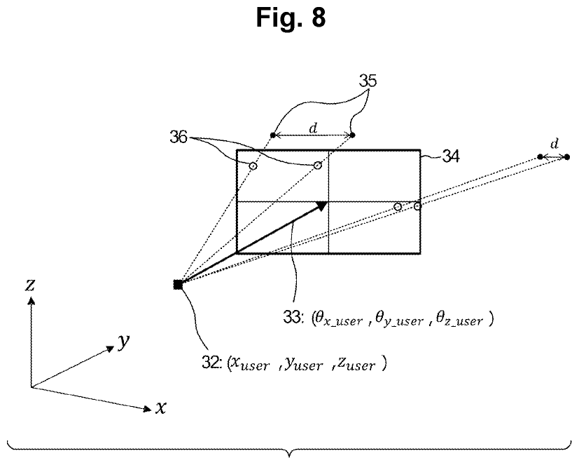

As a method of displaying a point cloud of the 3D VR space on the viewing terminal 1 that is a device having the drawing monitor 18, such as a PC, a smartphone, or an HMD, a method as illustrated in FIG. 8 can be adopted. FIG. 8 is a schematic diagram for explaining the method of displaying the point cloud of the 3D VR space on the viewing terminal 1. As illustrated in FIG. 8, it is performed by assuming a plane of a drawing screen 34 in the line-of-sight direction on the 3D VR space, and projecting a point cloud in the 3D VR space onto an intersection of a line segment connecting the viewpoint position 32 to a point 35 in the 3D VR space and the drawing screen 34. At this time, considering a pair of two points 35 in the 3D VR space, which are on the 3D VR space and separated from each other by a distance d in the 3D VR space coordinates, a distance between two projection points 36 projected on the drawing screen 34 is relatively shorter in a pair of two points far from the viewpoint position 32 than in a pair of two points near the viewpoint position 32. That is, even if a point cloud exists with a certain point cloud density in the 3D VR space, a state occurs in which an area closer to the viewpoint position 32 looks sparser on the drawing screen 34, and an area farther from the viewpoint position 32 looks denser.

In the present embodiment, using a data structure capable of expressing a plurality of pieces of point information with a plurality of densities, a point cloud near the viewpoint position 32 and the line-of-sight direction 33 is made dense as it is, and a point cloud in the distance is made sparse by reducing the number of points. By doing this, the number of points handled in the graphics processing is reduced as compared with a case where calculation is performed with a dense point cloud for the entire 3D VR space without largely impairing point cloud density feeling on the drawing screen 34, and the problem of the amount of calculation processing is solved, which is the first problem. In addition, a storage area including three layers of a server, a local storage, and a memory for graphics processing is used to appropriately control a storage range and a storage location of a point cloud having a data structure expressed with a plurality of densities on the basis of the viewpoint position 32 and the line-of-sight direction 33 in the 3D VR space. By doing this, the problem of exceeding the data area in the local storage and the memory, which is the second problem, and the problem of increasing the time required to download data from the server, which is the third problem, are solved.

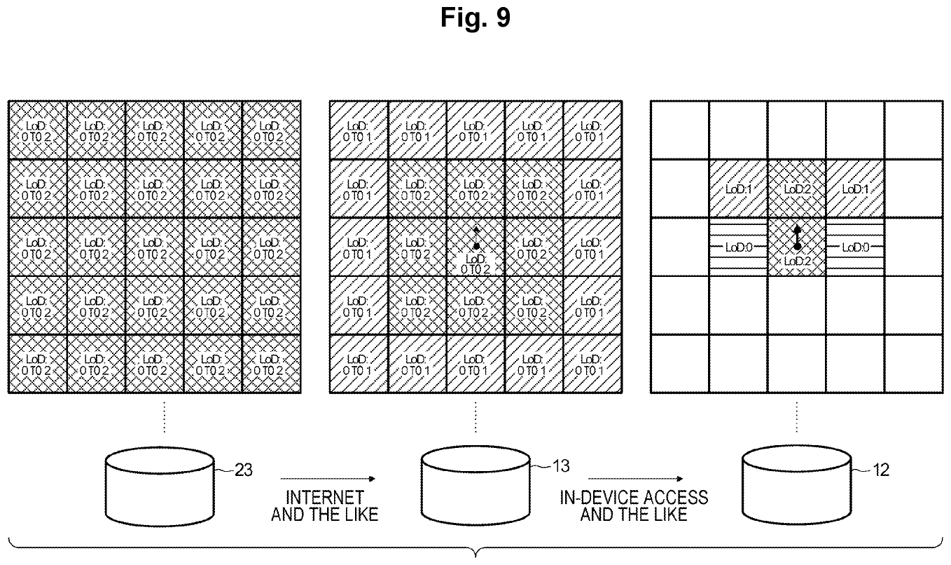

FIG. 9 is a schematic diagram illustrating a relationship between the storage range and the storage location of the point cloud in the storage areas of three layers, and the viewpoint position 32 and the line-of-sight direction 33 in the 3D VR space. That is, FIG. 9 illustrates a relationship between the data storage 23 of the point cloud data distribution server 2 and the data storage 13 and the data memory 12 of the viewing terminal 1, which are the storage areas of three layers, and the storage range and the storage location of the point cloud having the data structure expressed with the plurality of densities and the viewpoint position 32 and the line-of-sight direction 33 in the 3D VR space. The data memory 12 that is a memory for graphics generally has a limited storage capacity, and has a smaller storage area than the data storage 23 that is a server storage and the data storage 13 that is a local storage. In addition, if a large amount of point cloud information is read into the data memory 12 and display calculation is performed, the amount of calculation becomes too large. For that reason, it is desirable to read point cloud information into the data memory 12 with a narrow area and a low point cloud density within a range in which viewing feeling is not greatly impaired. Thus, in the present embodiment, as illustrated in FIG. 9, the point cloud density is set to be high (LoD2) in an area (storage range and storage location) near the viewpoint position 32 and the line-of-sight direction 33, and the point cloud density is set to be low (LoD1, LoD0, or no point cloud reading) in a distant area or an invisible area. On the other hand, the data storage 23 that is a server storage generally easily secures a huge storage capacity. Thus, the data storage 23 stores data of all the point cloud densities (LoD0 to LoD2) of the entire area.

At this time, if an attempt is made to read, from the entire point cloud, a limited point cloud within a range in which the viewing feeling is not impaired directly from the data storage 23 of the point cloud data distribution server 2 into the data memory 12 that is a memory for graphics of the viewing terminal 1, the third problem becomes a problem. That is, in general, access between the data storage 23 and the data memory 12 requires a certain period of time while interposing the network NW network such as the Internet, and thus, reading cannot be performed in time when the viewpoint position 32 and/or the line-of-sight direction 33 is moved, and the user's viewing feeling is impaired.

Thus, in the present embodiment, the data storage 13 that is a local storage is interposed between the data storage 23 and the data memory 12. Then, point cloud information having a wider range and a higher density than the data memory 12 is read in advance in accordance with the viewpoint position 32 and/or the line-of-sight direction 33 also into the data storage 13, whereby the third problem is solved. In addition, although the data storage 13 generally has a larger storage area than the data memory 12, there are more restrictions than the data storage 23 of the point cloud data distribution server 2. For that reason, point cloud information on all the points is not collectively read into the data storage 13, but point cloud information having a wider range than point cloud information read into the data memory 12 and a lower density than point cloud information stored in the data storage 23 is read in accordance with the viewpoint position 32 and/or the line-of-sight direction 33, whereby the second problem is solved.

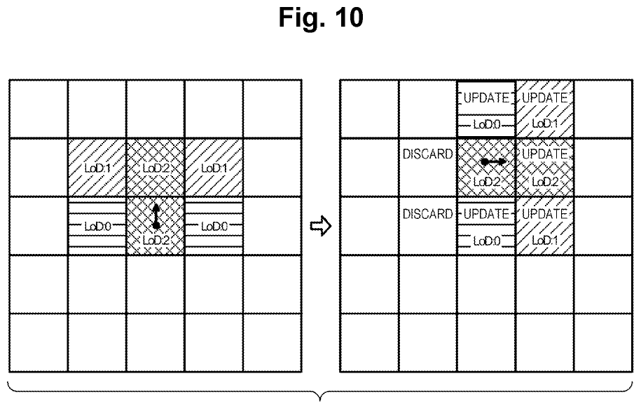

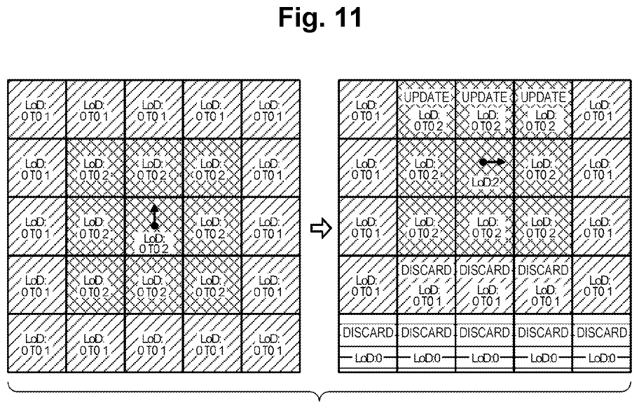

FIGS. 10 and 11 are schematic diagrams for explaining update of point cloud information in the data memory 12 and the data storage 13 in a case where the viewpoint position 32 and/or the line-of-sight direction 33 in the 3D VR space is moved. By reading point cloud information into each of the storage areas of three layers as in the present embodiment, even if the viewpoint position and/or the line-of-sight direction in the 3D VR space is moved, for example, as illustrated in FIG. 10, for the point cloud on the data memory 12, point cloud information is updated from the data storage 13 at a higher speed than for the point cloud data distribution server 2, and point cloud information is discarded for a portion having a low importance, so that the storage area of point cloud information for calculation processing is kept small. Similarly, as illustrated in FIG. 11, for the point cloud on the data storage 13, the data storage 13 reads, from the point cloud data distribution server 2 in advance, point cloud information around the viewpoint position 32 and in a direction closer to the line-of-sight direction 33, which is likely to be required in the data memory 12, up to a point cloud having a higher density as being closer to the viewpoint position 32 and the line-of-sight direction 33. By doing this, it is possible to pass point cloud information to the data memory 12 at a higher speed than directly accessing the point cloud data distribution server 2 from the data memory 12. In addition, in the data storage 13 as well, point cloud information far from the viewpoint position 32 and the line-of-sight direction 33 is read up to a point cloud with low density, whereby it is implemented that the storage area of the data storage 13 is kept small.

Next, a description will be given of each unit of the functional configurations of the viewing terminal 1 and the point cloud data distribution server 2.

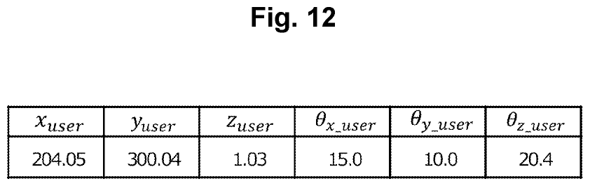

The in-space position/direction DB 121 of the viewing terminal 1 is used to hold the viewpoint position 32 and the line-of-sight direction 33 that are a position and a center direction of a user viewpoint in world coordinates in the 3D VR space. FIG. 12 is a schematic diagram for explaining an example of a storage format of the viewpoint position 32 and the line-of-sight direction 33 in the world coordinates in the in-space position/direction DB 121. The viewpoint position 32 and the line-of-sight direction 33 of the user in the world coordinates can be expressed by six variables such as xᵤₛₑᵣ, yᵤₛₑᵣ, zᵤₛₑᵣ, θ_{x_user}, θ_{y_user}, and θ_{z_user}, for example, as illustrated in FIG. 12.

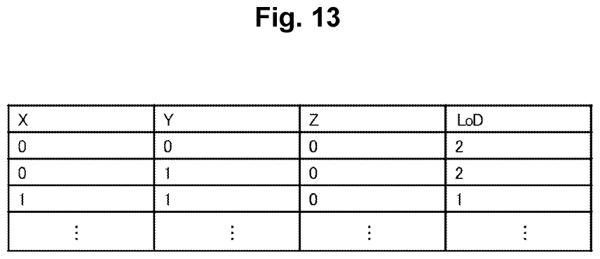

The local memory point cloud requester 122 of the viewing terminal 1 is used to hold a point cloud area (cubic space 31) that needs to be read according to the viewpoint position and the line-of-sight direction of the user. When the entire 3D VR space is represented as a space (three-dimensional box space coordinates) divided into three axes of X, Y, and Z axes by the cubic space 31 having a certain size as illustrated in FIG. 6, the local memory point cloud requester 122 stores an array list indicating which X, Y, and Z values of the three-dimensional box space coordinates point cloud information in each cubic space 31 belongs to and which LoD level the point cloud information is associated with. FIG. 13 is a schematic diagram for explaining an example of a storage format of the array list in the local memory point cloud requester 122. As illustrated in FIG. 13, each divided cubic space 31 is expressed by X, Y, and Z values and LoD values of the three-dimensional box space coordinates.

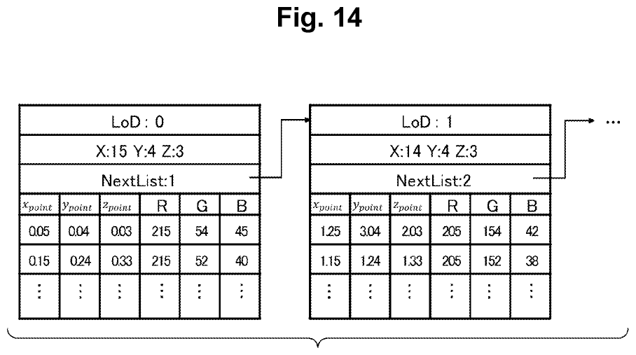

The local memory point cloud map 123 of the viewing terminal 1 is used to actually store point cloud information. Specifically, the local memory point cloud map 123 stores information indicating which cubic space 31 stores a point cloud with which LoD level, and all point cloud information included in the cubic space 31, for each cubic space 31 dividing the entire 3D VR space indicated by the three-dimensional box space coordinates. FIG. 14 is a schematic diagram for explaining an example of a storage format of information regarding each cubic space 31 in the local memory point cloud map 123. As illustrated in FIG. 14, the information regarding each cubic space 31 includes a LoD level of the cubic space 31, box numbers of the X, Y, and Z axes of each cubic space 31 in the entire 3D VR space, world coordinates (xₚₒᵢₙₜ, yₚₒᵢₙₜ, zₚₒᵢₙₜ) and color information (R, G, B) of each point cloud included in the cubic space 31, and finally, a pointer address of a next cubic space 31 for forming the array list.

The local memory point cloud status 124 of the viewing terminal 1 is used to manage a point cloud area of the point cloud information stored in the local memory point cloud map 123. Specifically, the local memory point cloud status 124 stores LoD information on a point cloud read into the local memory point cloud map 123. The local memory point cloud status 124 stores the LoD information on the point cloud read into the local memory point cloud map 123 in a data expression similar to the storage format of the array list in the local memory point cloud requester 122 illustrated in FIG. 13. The local memory point cloud status 124 is different from the local memory point cloud requester 122 in that the LoD information on the point cloud actually read into the local memory point cloud map 123 is indicated.

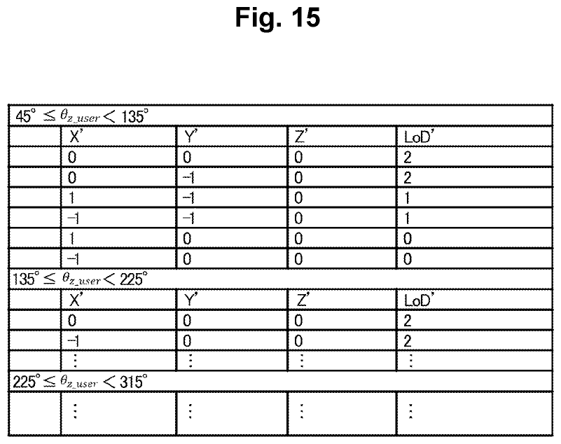

The local memory read area map 125 of the viewing terminal 1 is used to store a point cloud area that needs to be read according to the viewpoint position and the line-of-sight direction of the user. Specifically, the local memory read area map 125 stores information for making unique association between which cubic space 31 and which LoD to be acquired among all the cubic spaces 31 obtained by dividing the entire 3D VR space when the user takes the specific viewpoint position 32 and line-of-sight direction 33 in the 3D VR space. In the present embodiment, as a simple association method, association is performed in a data format illustrated in FIG. 15.

FIG. 15 is a schematic diagram for explaining an example of a storage format of association of the viewpoint position 32 and the line-of-sight direction 33 on the local memory read area map 125 with the cubic space 31 and LoD to be acquired. As illustrated in FIG. 15, the local memory read area map 125 stores them in a format in which a plurality of sets is arranged of ranges of rotation angles θz in the z axis direction of the line-of-sight direction 33 in the 3D VR space, three-dimensional box space coordinate values (X′, Y′, Z′), and LoD values. The data illustrated in FIG. 15 indicates that when 3D VR space coordinates (xᵤₛₑᵣ, yᵤₛₑᵣ, zᵤₛₑᵣ) of the viewpoint position 32 are within three-dimensional box space coordinates (Xₙ, Yₙ, Zₙ), the cubic space 31 at a relative distance (X′, Y′, Z′) in the three-dimensional box space coordinates from the three-dimensional box space coordinates (Xₙ, Yₙ, Zₙ) is acquired with a LoD value indicated with Lod′. Note that, assuming that both coordinates are in the same right-handed system, the origins match each other, and axes are directed in the same directions, (xᵤₛₑᵣ/α, yᵤₛₑᵣ/α, zᵤₛₑᵣ/α)=(Xₙ, Yₙ, Zₙ) is satisfied when one cubic space side of the three-dimensional box space coordinates is a distance x in the 3D VR space coordinates, and the association between the 3D VR space coordinates (xᵤₛₑᵣ, yᵤₛₑᵣ, zᵤₛₑᵣ) and the three-dimensional box space coordinates (Xₙ, Yₙ, Zₙ) can be easily obtained. However, in the left side of this expression, fractions below the decimal point are rounded down.

The local storage point cloud requester 126 of the viewing terminal 1 is used to hold a point cloud area that needs to be read according to the viewpoint position and the line-of-sight direction of the user. Specifically, the local storage point cloud requester 126 stores LoD information on a point cloud to be read into the local storage point cloud map 131. The local storage point cloud requester 126 stores the LoD information on the point cloud to be read into the local storage point cloud map 131 in a data expression similar to the storage format of the array list in the local memory point cloud requester 122 illustrated in FIG. 13.

The local storage point cloud status 127 of the viewing terminal 1 is used to manage a point cloud area of point cloud information stored in the local storage point cloud map 131. Specifically, the local storage point cloud status 127 stores the LoD information on the point cloud actually read into the local storage point cloud map 131. The local storage point cloud status 127 also stores the LoD information on the point cloud actually read in the local storage point cloud map 131 in a data expression similar to the storage format of the array list in the local memory point cloud requester 122 illustrated in FIG. 13.

The Local storage read area map 128 of the viewing terminal 1 is used to store a point cloud area that needs to be read according to the viewpoint position and the line-of-sight direction of the user. Specifically, similarly to the local memory read area map 125 illustrated in FIG. 15, the Local storage read area map 128 stores information for making unique association between which cubic space 31 and which LoD to be acquired among all the cubic spaces 31 obtained by dividing the entire 3D VR space when the user takes the specific viewpoint position 32 and line-of-sight direction 33 in the 3D VR space.

The local storage point cloud map 131 of the viewing terminal 1 is used to actually store point cloud information. Specifically, the local storage point cloud map 131 stores, in a format similar to that of the local memory point cloud map 123 illustrated in FIG. 14, information indicating which cubic space 31 stores a point cloud with which LoD level, and all point cloud information included in the cubic space 31, for each cubic space 31 dividing the entire 3D VR space indicated by the three-dimensional box space coordinates.

The server storage point cloud map 231 of the point cloud data distribution server 2 stores, in a format similar to that of the local memory point cloud map 123 of the viewing terminal 1 illustrated in FIG. 14, information indicating which cubic space 31 stores a point cloud with which LoD level, and all point cloud information included in the cubic space 31, for each cubic space 31 dividing the entire 3D VR space indicated by the three-dimensional box space coordinates. The server storage point cloud map 231 stores point cloud information in all the LoDs of all the cubic spaces 31 from an initial state.

An amount of data of the point cloud information read into the local storage point cloud map 131 and an amount of data of the point cloud information read into the local memory point cloud map 123 are determined by read area map data stored in the format illustrated in FIG. 15. For that reason, the read area map data is desirably set such that the local storage read area map 128 has a wider area and a higher LoD than the local memory read area map 125. In addition, a range and LoD specified by the Local storage read area map 128 need to cover a range and LoD data specified by the local memory read area map 125.

As described above, in the present embodiment, a range of data reading to the local memory point cloud map 123 and the local storage point cloud map 131 according to the viewpoint position 32 and the line-of-sight direction 33 is set by setting data onto the memory and the storage called the read area map data.

In addition, the viewpoint position acquisition processing unit 111 of the viewing terminal 1 has a function of acquiring the viewpoint position and the line-of-sight direction of the user from the viewpoint position controller 17. Specifically, the viewpoint position acquisition processing unit 111 of the viewing terminal 1 acquires the viewpoint position 32 (xᵤₛₑᵣ, yᵤₛₑᵣ, zᵤₛₑᵣ, θ_{x_user}) and the line-of-sight direction 33 (θ_{y_user}, θ_{z_user}) of the user in the world coordinates from the viewpoint position controller 17 via the input/output interface 14. Then, the acquired viewpoint position 32 and line-of-sight direction 33 are stored in the in-space position/direction DB 121 as position/direction control information. Note that, in a case where the viewpoint position controller 17 outputs the viewpoint position 32 and the line-of-sight direction 33 at all times, the viewpoint position acquisition processing unit 111 acquires the viewpoint position 32 and the line-of-sight direction 33 at certain time intervals that are short enough to present the 3D VR space expressed by the point cloud to the user following a change in the viewpoint position and the line-of-sight direction of the user. In addition, in a case where the viewpoint position controller 17 outputs the viewpoint position 32 and the line-of-sight direction 33 according to a change in the viewpoint position and the line-of-sight direction of the user, the viewpoint position acquisition processing unit 111 acquires the viewpoint position and the line-of-sight direction according to reception of the output of the viewpoint position controller 17.

The point cloud rendering processing unit 112 of the viewing terminal 1 is a display control unit that reads point cloud information from the local memory point cloud map 123 and displays the point cloud information on the drawing monitor 18 via the input/output interface 14.

The local memory position monitoring processing unit 113 of the viewing terminal 1 has a function of monitoring the viewpoint position and the line-of-sight direction of the user stored in the in-space position/direction DB 121, and determining which cubic space 31 point cloud information is downloaded and stored in the local memory point cloud map 123 in a case where at least one of the viewpoint position or the line-of-sight direction is changed. Specifically, the local memory position monitoring processing unit 113 acquires position/direction information in the 3D VR space from the in-space position/direction DB 121, acquires read area information from the local memory read area map 125, and recalculates a DL request state on the basis of the acquired position/direction information and read area information. In addition, the local memory position monitoring processing unit 113 acquires a download (Hereinafter, it is abbreviated as DL.) request state from the local memory point cloud requester 122, and if this DL request state is different from the recalculated DL request state, updates the local memory point cloud requester 122 with the recalculated DL request state.

The local memory map update processing unit 114 of the viewing terminal 1 has a function of acquiring point cloud information from the local storage point cloud map 131 on the basis of the DL request state of the local memory point cloud requester 122 and storing the point cloud information in the local memory point cloud map 123. In addition, the local memory map update processing unit 114 has a function of confirming the local memory point cloud status 124 storing a download state of the point cloud information of the local memory point cloud map 123 not to perform unnecessary download at the time of this download. In addition, the local memory map update processing unit 114 also has a function of updating the local memory point cloud status 124 when storing the downloaded point cloud information in the local memory point cloud map 123. Specifically, the local memory map update processing unit 114 acquires a DL request state from the local memory point cloud requester 122, acquires a DL state of a confirmation target from the local memory point cloud status 124, and calculates point cloud area/level information on a difference between the DL request state and the DL state. In addition, the local memory map update processing unit 114 determines whether or not there is a difference between a set of elements that exist in the DL request state but do not exist in the DL state and a set of elements that exist in the DL state but do not exist in the DL request state on the contrary, in the calculated point cloud area/level information on the difference. In a case where there is a difference between the sets of elements, the local memory map update processing unit 114 acquires the DL state from the local storage point cloud status 127, and acquires point cloud information from the local storage point cloud map 131 on the basis of point cloud area/level information existing in the DL state in the calculated point cloud area/level information on the difference. In addition, the local memory map update processing unit 114 updates a list of the local memory point cloud map 123 according to the acquired point cloud information. At this time, the local memory map update processing unit 114 may delete a point cloud of the local memory point cloud map 123 on the basis of the calculated point cloud area/level information on the difference. In addition, the local memory map update processing unit 114 updates the DL state of the local memory point cloud status 124 to cause the DL state to match the updated point cloud information of the local memory point cloud map 123.

The local storage position monitoring processing unit 115 of the viewing terminal 1 has a function of monitoring the viewpoint position and the line-of-sight direction of the user stored in the in-space position/direction DB 121, and determining which cubic space 31 point cloud information is downloaded and stored in the local storage point cloud map 131 in a case where at least one of the viewpoint position or the line-of-sight direction is changed. Specifically, position/direction information in the 3D VR space is acquired from the in-space position/direction DB 121, read area information is acquired from the local storage read area map 128, and a DL request state is recalculated on the basis of the acquired position/direction information and read area information. In addition, the local storage position monitoring processing unit 115 acquires a DL request state from the local storage point cloud requester 126, and if this DL request state is different from the recalculated DL request state, updates the local storage point cloud requester 126 with the recalculated DL request state.

The local storage map update processing unit 116 of the viewing terminal 1 has a function of acquiring point cloud information from the server storage point cloud map 231 of the point cloud data distribution server 2 on the basis of a DL request state of the local storage point cloud requester 126 and storing the point cloud information in the local storage point cloud map 131. In addition, the local storage map update processing unit 116 has a function of confirming the local storage point cloud status 127 storing a download state of the point cloud information of the local storage point cloud map 131 not to perform unnecessary download at the time of this download. In addition, the local storage map update processing unit 116 also has a function of updating the local storage point cloud status 127 when storing the downloaded point cloud information in the local storage point cloud map 131. Specifically, the local storage map update processing unit 116 acquires a DL request state from the local storage point cloud requester 126, acquires a DL state of a confirmation target from the local storage point cloud status 127, and calculates point cloud area/level information on a difference between the DL request state and the DL state. In addition, the local storage map update processing unit 116 determines whether or not there is a difference between a set of elements that exist in the DL request state but do not exist in the DL state and a set of elements that exist in the DL state but do not exist in the DL request state on the contrary, in the calculated point cloud area/level information on the difference. In a case where there is a difference between the sets of elements, an individual request for necessary data in units of cubic spaces 31 is made to the server point cloud data distribution processing unit 211 of the processing unit 21 of the point cloud data distribution server 2 via the network NW by the communication interface 15, and point cloud area/level information and all point cloud information of the cubic spaces 31 stored in the server storage point cloud map 231 are received. In addition, the local storage map update processing unit 116 adds acquired point cloud area/level information and all point cloud information of one cubic space 31 to a list of the local storage point cloud map 131, and updates the DL state of the local storage point cloud status 127 on the basis of the point cloud area/level information. The local storage map update processing unit 116 repeats download of the point cloud area/level information and all point cloud information from the server storage point cloud map 231 in units of cubic spaces 31, addition of the downloaded data to the local storage point cloud map 131, and update of the DL state of the local storage point cloud status 127 until all necessary data are downloaded. When all the necessary data are downloaded, the local storage map update processing unit 116 may delete a point cloud of the local storage point cloud map 131 on the basis of the calculated point cloud area/level information on the difference. In addition, the local storage map update processing unit 116 updates the DL state of the local storage point cloud status 127 to cause the DL state to match the updated point cloud information of the local storage point cloud map 131.

Note that each of the processing units 111 to 116 of the viewing terminal 1 according to the present embodiment can be implemented by the processor 11A and the point cloud data display program stored in advance in the program memory 11B. However, the point cloud data display program can also be provided to the viewing terminal 1 by being recorded in a non-transitory computer-readable medium or via a network. The point cloud data display program thus provided can be stored in the program memory 11B. In addition, the provided point cloud data display program is stored in the data storage 13 that is a storage and is executed by the processor 11A, as necessary, whereby the processor 11A can function as the processing units 111 to 116.

In addition, the server point cloud data distribution processing unit 211 of the point cloud data distribution server 2 receives a necessary data request from the local storage map update processing unit 116 of the viewing terminal 1, and acquires point cloud information based on the necessary data request from the server storage point cloud map 231. In addition, the server point cloud data distribution processing unit 211 transmits the acquired point cloud information to the local storage map update processing unit 116.

The server point cloud data distribution processing unit 211 can also be implemented by the processor and the point cloud data distribution program stored in advance in the program memory. However, the point cloud data distribution program can also be provided to the point cloud data distribution server 2 by being recorded in a non-transitory computer-readable medium or via a network. The point cloud data distribution program thus provided can be stored in the program memory. In addition, the provided point cloud data distribution program is stored in the data storage 23 that is a storage and executed by the processing unit, as necessary, whereby the processor can function as the server point cloud data distribution processing unit 211.

### (Operation)

Next, a description will be given of operation of the viewing terminal 1 and the point cloud data distribution server 2 configured as described above.

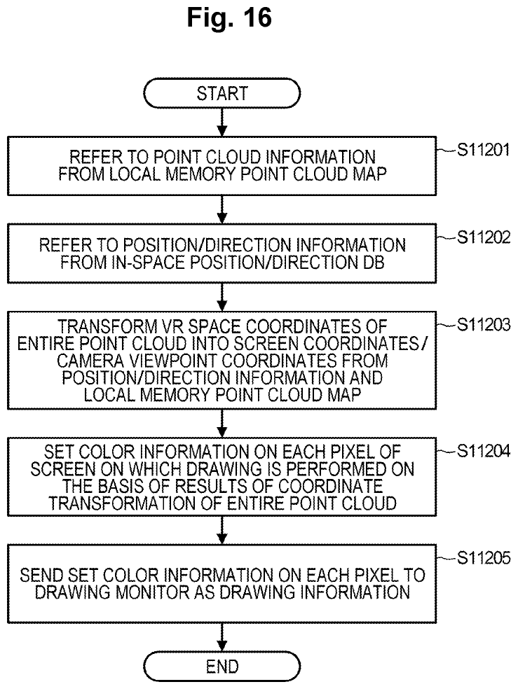

FIG. 16 is a flowchart illustrating an example of an operation processing procedure by the point cloud rendering processing unit 112 of the viewing terminal 1. The processor 11A of the viewing terminal 1 can execute operation processing in the flowchart by executing the point cloud data display program stored in advance in the program memory 11B, for example. The operation processing illustrated in the flowchart is started as an independent thread at a time of executing the point cloud data display program, and is continuously executed in a loop by restarting after an end of the operation processing.

The point cloud rendering processing unit 112 refers to all the point cloud information on the entire cubic space 31 included in the local memory point cloud map 123 (step S11201). The point cloud information to be referred to is position coordinates and RGB information in the 3D VR space.

Subsequently, the point cloud rendering processing unit 112 refers to position/direction information in the 3D VR space from the in-space position/direction DB 121 (step S11202). The position/direction information to be referred to is the viewpoint position 32 (xᵤₛₑᵣ, yᵤₛₑᵣ, zᵤₛₑᵣ) and the line-of-sight direction (θ_{x_user}, θ_{y_user}, θ_{z_user}) in the 3D VR space.

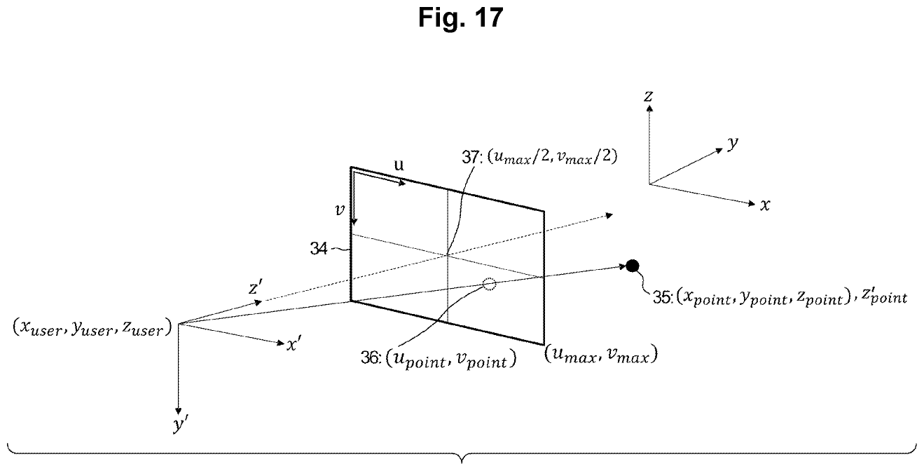

Next, the point cloud rendering processing unit 112 transforms VR space coordinates of the entire point cloud into screen coordinates/camera viewpoint coordinates from the position/direction information and the local memory point cloud map 123 (step S11203). Specifically, in a case where a virtual viewpoint camera is placed at the viewpoint position 32 and the line-of-sight direction 33 (xᵤₛₑᵣ, yᵤₛₑᵣ, zᵤₛₑᵣ, θ_{x_user}, θ_{y_user}, θ_{z_user}) in the 3D VR space acquired in step S11202, the point cloud rendering processing unit 112 calculates a projection point 36 (uₚₒᵢₙₜ, vₚₒᵢₙₜ) at which position information (xₚₒᵢₙₜ, yₚₒᵢₙₜ, zₚₒᵢₙₜ) in the 3D VR space of each point 35 in the 3D VR space acquired in step S11201 is projected on a screen coordinate system (u, v) corresponding to a viewpoint camera coordinate system (x′, y′, z′). Further, in that case, the point cloud rendering processing unit 112 calculates a value z′ₚₒᵢₙₜ of the z′ axis of viewpoint camera coordinates of the point 35 arranged in (xₚₒᵢₙₜ, yₚₒᵢₙₜ, zₚₒᵢₙₜ) in the 3D VR space. A relationship in coordinate transformation of the present processing operation is illustrated in FIG. 17.

FIG. 17 is a schematic diagram for explaining coordinate transformation of points arranged in the 3D VR space into the screen coordinate system u, v of the drawing screen 34 corresponding to the viewpoint position 32 and the line-of-sight direction 33 in the 3D VR space. A plane of two axes of the screen coordinate system u, v is the same as a plane defined by z′=1 in the viewpoint camera coordinate system x′, y′, z′. The coordinates (uₘₐₓ, vₘₐₓ) in FIG. 17 are constants uniquely determined by the number of pixels and the viewing angle of the drawing monitor. In addition, the origin of the viewpoint camera coordinate system x′, y′, z′ is the viewpoint position (xᵤₛₑᵣ, yᵤₛₑᵣ, zᵤₛₑᵣ) in the 3D VR space acquired in step S11202, and the line-of-sight direction 33 in the 3D VR space acquired in step S11202 coincides with the z′ axis of the viewpoint camera coordinates. A coordinate (uₘₐₓ/2, vₘₐₓ/2) of the z′ axis on the drawing screen 34 is an intersection point 37 of the viewpoint camera coordinate system x′, y′, z′ and the screen coordinate system u, v. At this time, a method of calculating the projection point 36 (uₚₒᵢₙₜ, vₚₒᵢₙₜ) and z′ₚₒᵢₙₜ on the drawing screen 34 from the position coordinates of the position information (xₚₒᵢₙₜ, yₚₒᵢₙₜ, zₚₒᵢₙₜ) in the 3D VR space of each point cloud acquired in step S11201 is a calculation widely known in general in computer graphics, and can be obtained by a matrix calculation.

Next, the point cloud rendering processing unit 112 sets color information (RGB information) on each of pixels of a screen on which drawing is performed, for all the pixels in the screen coordinates, on the basis results of calculation of the entire point cloud subjected to coordinate transformation in step S11203 (step S11204). Specifically, the point cloud rendering processing unit 112 checks, for each pixel, whether or not there is a point 35 in the 3D VR space, which is subjected to coordinate transformation to be projected on the pixel and satisfies z′ₚₒᵢₙₜ>0. In a case where there is a corresponding point 35 in the 3D VR space, a point 35 having the smallest z′ₚₒᵢₙₜ is selected, and RGB information corresponding to the point 35 is set as color information to be drawn in the pixel. In a case where there is no corresponding point, RGB information of the pixel is set to (0, 0, 0).

Then, the point cloud rendering processing unit 112 sends drawing information to the drawing monitor 18 on the basis of a result of setting the color information (RGB information) for each pixel in the screen coordinates in step S11204 (step S11205). When the sending is ended, the point cloud rendering processing unit 112 ends the operation processing procedure illustrated in the flowchart and starts the operation processing in step S11201 again.

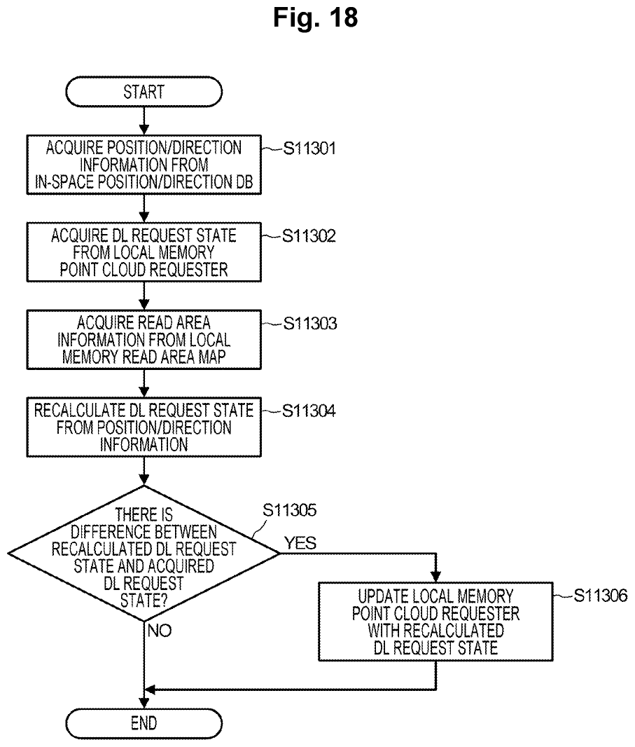

FIG. 18 is a flowchart illustrating an example of an operation processing procedure by the local memory position monitoring processing unit 113 of the viewing terminal 1. The processor 11A of the viewing terminal 1 can execute operation processing in the flowchart by executing the point cloud data display program stored in advance in the program memory 11B, for example. The operation processing illustrated in the flowchart is started as an independent thread at a time of executing the point cloud data display program, and is continuously executed in a loop by restarting after an end of the operation processing.

The local memory position monitoring processing unit 113 acquires position/direction information in the 3D VR space from the in-space position/direction DB 121 (step S11301). The position/direction information to be acquired is the viewpoint position 32 (xᵤₛₑᵣ, yᵤₛₑᵣ, zᵤₛₑᵣ) and the line-of-sight direction (θ_{x_user}, θ_{y_user}, θ_{z_user}) in the 3D VR space.

In addition, the local memory position monitoring processing unit 113 acquires a DL request state from the local memory point cloud requester 122 (step S11302). Information to be acquired is integer values of X, Y, and Z axes indicating each of cubic spaces 31 of the three-dimensional box space coordinates and a list of LoDs of the cubic spaces 31. Hereinafter, for the sake of description, the number of lists is set as p, and acquired data are expressed as (X₁, Y₁, Z₁, LoD₁), . . . , (Xₚ, Yₚ, Zₚ, LoDₚ).

Further, the local memory position monitoring processing unit 113 acquires read area information from the local memory read area map 125 (step S11303). Specifically, the local memory position monitoring processing unit 113 uses a value of θ_{z_user} in a viewing direction acquired in step S11301 to acquire a list of values of X′, Y′, Z′, and LoD′ corresponding to the value of θz_user.

Then, the local memory position monitoring processing unit 113 recalculates the DL request state from the position/direction information in the 3D VR space acquired in step S11301 (step S11304). Specifically, the local memory position monitoring processing unit 113 first calculates, from position coordinates (xᵤₛₑᵣ, yᵤₛₑᵣ, zᵤₛₑᵣ) acquired in step S11301, three-dimensional box space coordinates (Xₙ, Yₙ, Zₙ) to which the position coordinates belong on the basis of the (xᵤₛₑᵣ/α, yᵤₛₑᵣ/α, zᵤₛₑᵣ/α)=(Xₙ, Yₙ, zₙ) (however, in the left side, fractions below the decimal point are rounded down) described above. Next, the local memory position monitoring processing unit 113 calculates (X′₁+Xₙ, Y′₁+Yₙ, Z′₁+Zₙ, LoD′₁), . . . , (X′ᵢ+Xₙ, Y′ᵢ+Yₙ, Z′ᵢ+Zₙ, LoD′ᵢ) with respect to i pieces of lists of X′, Y′, Z′ and LoD′, (X′₁, Y′₁, Z′₁, LoD′₁), . . . , (X′ᵢ, Y′ᵢ, Z′ᵢ, LoD′ᵢ), acquired in step S11303. At this time, (X′₁+Xₙ, Y′₁+Yₙ, Z′₁+Zₙ, LoD′₁), . . . , (X′ᵢ+X, Y′ᵢ+Yₙ, Z′ᵢ+Zₙ, LoD′ᵢ) are the recalculated DL request state.

Here, the local memory position monitoring processing unit 113 determines whether or not the DL request state (X′₁+Xₙ, Y′₁+Yₙ, Z′₁+Zₙ, LoD′₁), . . . , (X′ᵢ+Xₙ, Y′ᵢ+Yₙ, Z′ᵢ+Zₙ, LoD′ᵢ) recalculated in step S11304 match the DL request state (X₁, Y₁, Z₁, LoD₁), . . . , (Xₚ, Yₚ, Zₚ, LoDₚ) acquired in step S11302 (step S11305). In a case where both states match each other, the local memory position monitoring processing unit 113 ends the operation processing procedure illustrated in the flowchart and starts the operation processing in step S11301 again.

On the other hand, in a case where it is determined in step S11305 that the recalculated DL request state does not match the acquired DL request state, the local memory position monitoring processing unit 113 updates the local memory point cloud requester 122 with the recalculated DL request state (step S11306). Specifically, the local memory position monitoring processing unit 113 updates the local memory point cloud requester 122 by deleting all values of the local memory point cloud requester 122 and adding the DL request state (X′₁+Xₙ, Y′₁+Yₙ, Z′₁+Zₙ, LoD′₁), . . . , (X′ᵢ+Xₙ, Y′ᵢ+Yₙ, Z′ᵢ+Zₙ, LoD′ᵢ) recalculated in step S11304 to the local memory point cloud requester 122. When the update is ended, the local memory position monitoring processing unit 113 ends the operation processing procedure illustrated in the flowchart and starts the operation processing in step S11301 again.

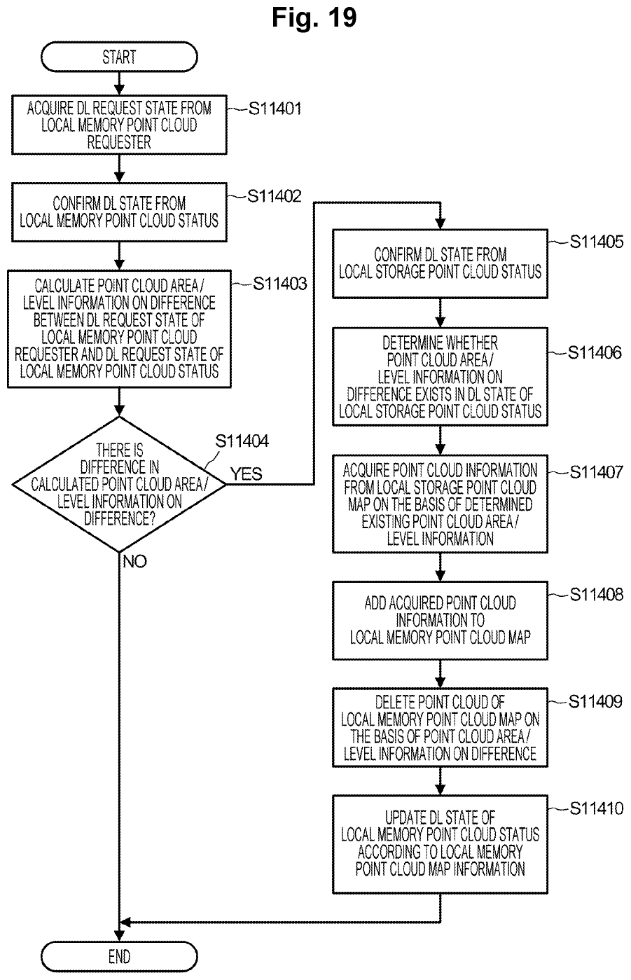

FIG. 19 is a flowchart illustrating an example of an operation processing procedure by the local memory map update processing unit 114 of the viewing terminal 1. The processor 11A of the viewing terminal 1 can execute operation processing in the flowchart by executing the point cloud data display program stored in advance in the program memory 11B, for example. The operation processing illustrated in the flowchart is started as an independent thread at a time of executing the point cloud data display program, and is continuously executed in a loop by restarting after an end of the operation processing.

The local memory map update processing unit 114 acquires a DL request state from the local memory point cloud requester 122 (step S11401). Information to be acquired is integer values of X, Y, and Z axes indicating each of cubic spaces 31 of the three-dimensional box space coordinates and a list of LoDs of the cubic spaces 31. Hereinafter, for the sake of description, the number of lists is set as p, and acquired data is expressed as (X_{mr_1}, Y_{mr_1}, Z_{mr_1}, LoD_{mr_1}), . . . , (X_{mr_p}/Y_{mr_p}/Z_{mr_p}, LoD_{mr_p}).

In addition, the local memory map update processing unit 114 acquires a DL state of a confirmation target from the local memory point cloud status 124 (step S11402). Information to be acquired is integer values of X, Y, and Z axes indicating each of cubic spaces 31 of the three-dimensional box space coordinates and a list of LoDs of the cubic spaces 31. Hereinafter, for the sake of description, the number of lists is set as q, and acquired data is expressed as (X_{ms_1}, Y_{ms_1}, Z_{ms_1}, LoD_{ms_1}), . . . , (X_{ms_q}, Y_{ms_q}, Z_{ms_q}, LoD_{ms_q}).

Then, the local memory map update processing unit 114 calculates point cloud area/level information on a difference between the acquired DL request state of the local memory point cloud requester 122 and DL state of the local memory point cloud status 124 (step S11403). Hereinafter, a set of s elements that exist in the DL request state (X_{mr_1}, Y_{mr_1}, Z_{mr_1}, LoD_{mr_1}), . . . , (X_{mr_p}, Y_{mr_p}, Z_{mr_p}, LoD_{mr_p}) but do not exist in the DL state (X_{ms_1}/Y_{ms_1}, Z_{ms_1}, LoD_{ms_1}), . . . , (X_{ms_q}, Y_{ms_q}, Z_{ms_q}, LoD_{ms_q}) in the calculated point cloud area/level information on the difference is expressed as (X_{r_1}, Y_{r_1}, Z_{r_1}, LoD_{r_1}), . . . , (X_{r_s}, Y_{r_s}, Z_{r_s}, LoD_{r_s}). Conversely, a set of u elements that exist in the DL state (X_{ms_1}, Y_{ms_1}, Z_{ms_1}, LoD_{ms_1}), . . . , (X_{ms_q}, Y_{ms_q}, Z_{ms_q}, LoD_{ms_q}) but do not exist in the DL request state (X_{mr_1}, Y_{mr_1}, Z_{mr_1}, LoD_{mr_1}), . . . , (X_{mr_p}/Y_{mr_p}, Z_{mr_p}, LoD_{mr_p}) is expressed as (X_{d_1}, Y_{d_1}, Z_{d_1}, LoD_{d_1}), . . . , (X_{d_u}, Y_{d_u}, Z_{d_u}, LoD_{d_u}).

The local memory map update processing unit 114 determines whether or not there is a difference, that is, whether or not s=u=0 holds for two sets of elements in the point cloud area/level information on the difference calculated in step S11403 (step S11404). In a case where it is determined that there is no difference between the two sets of elements, the local memory map update processing unit 114 ends the operation processing procedure illustrated in the flowchart and starts the operation processing in step S11401 again.

On the other hand, in a case where it is determined that there is a difference between the two sets of elements, the local memory map update processing unit 114 acquires a DL state of a confirmation target from the local storage point cloud status 127 (step S11405). Information to be acquired is integer values of X, Y, and Z axes indicating each of cubic spaces 31 of the three-dimensional box space coordinates and a list of LoDs of the cubic spaces 31. Hereinafter, for the sake of description, the number of lists is set to v, and acquired data is expressed as (X_{ss_1}, Y_{ss_1}, Z_{ss_1}, LoD_{ss_1}), . . . , (X_{ss_v}, Y_{ss_v}, Z_{ss_v}, LoD_{ss_v}).

Subsequently, the local memory map update processing unit 114 determines whether or not the point cloud area/level information on the difference calculated in step S11403 exists in the DL state of the local storage point cloud status 127 acquired in step S11405 (step S11406). Specifically, a comparison is made between the set of elements (X_{r_1}, Y_{r_1}, Z_{r_1}, LoD_{r_1}), . . . , (X_{r_s}, Y_{r_s}, Z_{r_s}, LoD_{r_s}) in the calculated point cloud area/level information on the difference and the acquired DL state (X_{ss_1}, Y_{ss_1}, Z_{ss_1}, LoD_{ss_1}), . . . , (X_{ss_v}, Y_{ss_v}/Z_{ss_v}, LoD_{ss_v}), and w elements existing in both are calculated as (X_{r′_1}, Y_{r′_1}, Z_{r′_1}, LoD_{r′_1}), . . . , (X_{r′_w}/Y_{r′_w}/Z_{r′_w}, LoD_{r′_w}).

Next, the local memory map update processing unit 114 acquires point cloud information from the local storage point cloud map 131 on the basis of the existing point cloud area/level information determined in step S11406 (step S11407). Specifically, the local memory map update processing unit 114 acquires point cloud area/level information and all point cloud information (x_{point_1}, y_{point_1}, z_{point_1}, R₁, G₁, B₁), . . . of each cubic space 31, for data in which the w elements (X_{r′_1}, Y_{r′_1}, Z_{r′_1}, LoD_{r′_1}), . . . (X_{r′_w}/Y_{r′_w}, Z_{r′_w}, LoD_{r′_w}) calculated in step S11406 and numerical values of X, Y, Z, and LoD listed for each cubic space 31 of the local storage point cloud map 131 completely match.

In addition, the local memory map update processing unit 114 adds the point cloud area/level information and all point cloud information (x_{point_1}, y_{point_1}, z_{point_1}, R₁, G₁, B₁), . . . of each cubic space 31 acquired in step S11407 to the list of the local memory point cloud map 123 (step S11408).

At this time, the local memory map update processing unit 114 deletes a point cloud of the local memory point cloud map 123 on the basis of the point cloud area/level information on the difference calculated in step S11403 (step S11409). Specifically, the local memory map update processing unit 114 deletes point cloud area/level information and all point cloud information (x_{point_1}, y_{point_1}, z_{point_1}, R₁, G₁, B₁), . . . of each cubic space 31, for data in which the set of u elements (X_{d_1}, Y_{d_1}, Z_{d_1}, LoD_{d_1}), . . . , (X_{d_u}, Y_{d_u}, Z_{d_u}, LoD_{d_u}) of the point cloud area/level information on the difference calculated in step S11403 and numerical values of X, Y, Z, and LoD listed for each cubic space 31 of the local memory point cloud map 123 completely match. Note that the operation processing in step S11409 may be omitted. That is, the point cloud of the local memory point cloud map 123 may be deleted or may not be deleted.

Then, the local memory map update processing unit 114 updates the DL state of the local memory point cloud status 124 to cause the DL state to match the updated point cloud information of the local memory point cloud map 123 (step S11410). Specifically, the local memory map update processing unit 114 temporarily deletes all elements of the local memory point cloud status 124. Thereafter, the local memory map update processing unit 114 adds all data sets (X_{mm_1}; Y_{mm_1}; Z_{mm_1}; LoD_{mm_1}), . . . , (X_{mm_b}, Y_{mm_b}, Z_{mm_b}, LoD_{mm_b}) of X, Y, Z, and LoD with the number of elements b listed for each cubic space 31 of the local memory point cloud map 123 to the local memory point cloud status 124. In this way, the local memory map update processing unit 114 updates the DL state of the local memory point cloud status 124. When the update processing is ended, the local memory map update processing unit 114 ends the operation processing procedure illustrated in the flowchart and starts the operation processing in step S11401 again.

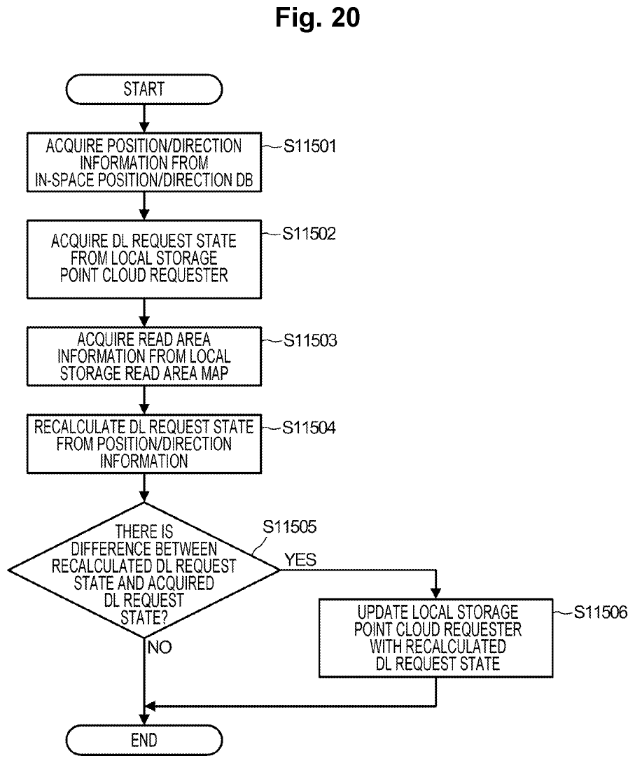

FIG. 20 is a flowchart illustrating an example of an operation processing procedure by the local storage position monitoring processing unit 115 of the viewing terminal 1. The processor 11A of the viewing terminal 1 can execute operation processing in the flowchart by executing the point cloud data display program stored in advance in the program memory 11B, for example. The operation processing illustrated in the flowchart is started as an independent thread at a time of executing the point cloud data display program, and is continuously executed in a loop by restarting after an end of the operation processing.

The operation processing procedure by the local storage position monitoring processing unit 115 illustrated in FIG. 20 is similar to the operation processing procedure by the local memory position monitoring processing unit 113 illustrated in FIG. 18 except that an acquisition source of the DL request state, an acquisition source of the read area information, and an update destination of the DL request state are the local storage read area map 128 and the local storage point cloud requester 126. Thus, a detailed description of the operation processing procedure by the local storage position monitoring processing unit 115 with reference to FIG. 20 will be omitted.

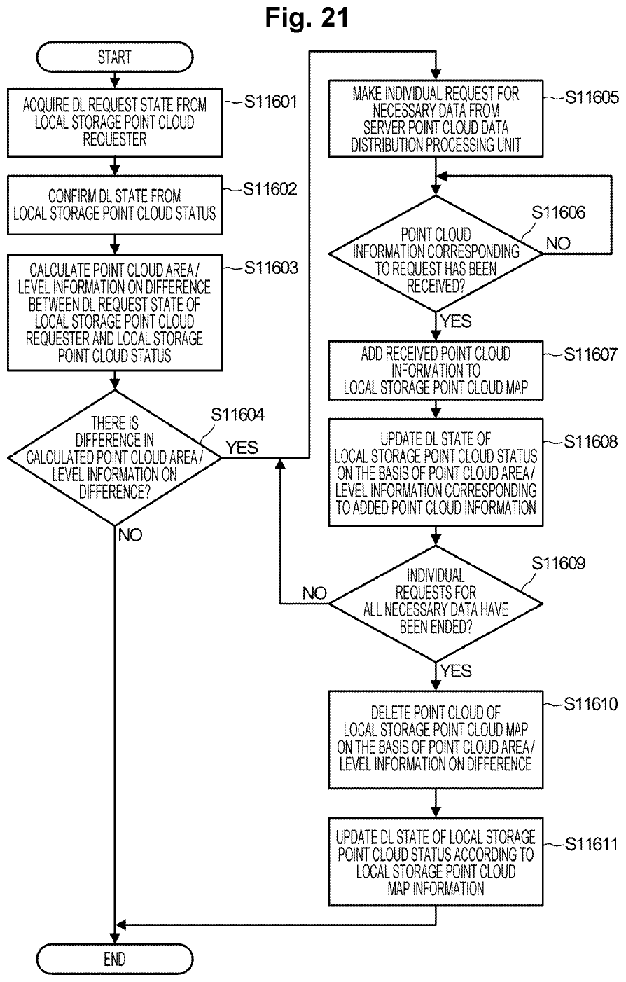

FIG. 21 is a flowchart illustrating an example of an operation processing procedure by the local storage map update processing unit 116 of the viewing terminal 1. The processor 11A of the viewing terminal 1 can execute operation processing in the flowchart by executing the point cloud data display program stored in advance in the program memory 11B, for example. The operation processing illustrated in the flowchart is started as an independent thread at a time of executing the point cloud data display program, and is continuously executed in a loop by restarting after an end of the operation processing.

The operation processing in steps S11601 to S11604 and steps S11610 to S11611 in the operation processing procedure by the local storage map update processing unit 116 illustrated in FIG. 21 is similar to the operation processing in steps S11401 to S11404 and steps S11409 to S11410 in the operation processing procedure by the local memory map update processing unit 114 illustrated in FIG. 19 except for a point below. A difference is that an acquisition source of the DL request state is the local storage point cloud requester 126, a point cloud deletion target is the local storage point cloud map 131, and an acquisition source of the DL state and an update destination of the DL request state are the local storage point cloud status 127. Thus, a detailed description of the operation processing procedure in steps S11601 to S11604 and steps S11610 to S11611 will be omitted.

Hereinafter, a description will be given of only the operation processing procedure in steps S11605 to S11609, which is a portion different from the operation processing procedure by the local memory map update processing unit 114. Note that the portion different from the operation processing procedure by the local memory map update processing unit 114 is that the local storage map update processing unit 116 does not check a cache state of a storage (server) one stage above itself. This is because it is assumed that there is the entire point cloud in the server storage point cloud map 231. That is, in an operation procedure by the local storage map update processing unit 116, there is no operation processing procedure such as checking the local storage point cloud status 127 from the local memory map update processing unit 114. In addition, the local memory map update processing unit 114 performs an operation processing procedure of acquiring all point cloud information in the storage area at a time and updating the status, but the local storage map update processing unit 116 performs an operation procedure of acquiring and updating the point cloud information one by one for each cubic space 31. This is because it is assumed that it takes a long time to acquire data between the point cloud data distribution server 2 and the local storage point cloud map 131.

Specifically, in a case where it is determined that there is a difference between two sets of elements in the point cloud area/level information on the difference in step S11604, the local storage map update processing unit 116 makes an individual request for necessary data from the server point cloud data distribution processing unit 211 of the processing unit 21 of the point cloud data distribution server 2 via the network NW by the communication interface 15 (step S11605). Specifically, the local storage map update processing unit 116 transmits information on an element (X_{r_i}, Y_{r_i}, Z_{r_i}, LoD_{r_i}) at the head of list data of (X_{r_1}, Y_{r_1}, Z_{r_1}, LoD_{r_1}), . . . , (X_{r_s}, Y_{r_s}, Z_{r_s}, LoD_{r_s}) to the server point cloud data distribution processing unit 211 as a request. Here, (X_{r_1}, Y_{r_1}, Z_{r_1}, LoD_{r_1}), . . . , (X_{r_s}, Y_{r_s}, Z_{r_s}, LoD_{r_s}) are a set of elements that exist in the DL request state acquired from the local storage point cloud requester 126 but do not exist in the DL state acquired from the local storage point cloud status 127. At this time, i is a register that is held in the local storage map update processing unit 116 or a partial storage area of the data memory 12 and has an initial value of “1”, and when a request is sent, a numerical value thereof is incremented by “1”. When the increment operation of i is ended, the local storage map update processing unit 116 advances the processing to the next step S11606.

Here, the local storage map update processing unit 116 determines whether or not data has been received from the server point cloud data distribution processing unit 211 as a response to the request transmitted in step S11605 (step S11606). Note that the received data are the point cloud area/level information (X_{r_i}, Y_{r_i}, Z_{r_i}, LoD_{r_i}) of one cubic space 31 of the server storage point cloud map 231 matching the request in step S11605 and all point cloud information (x_{point_1}, y_{point_1}, z_{point_1}, R₁, G₁, B₁), . . . included in the cubic space 31. In a case where the reception is not completed, the local storage map update processing unit 116 continues the processing in step S11606. When the reception processing is completed, the local storage map update processing unit 116 advances the processing to the next step S11607.

The local storage map update processing unit 116 adds the point cloud area/level information (X_{r_i}, Y_{r_i}, Z_{r_i}, LoD_{r_i}) and all point cloud information (x_{point_1}, y_{point_1}, z_{point_1}, R₁, G₁, B₁), . . . of one cubic space 31 acquired in step S11606 to the list of the local storage point cloud map 131 (step S11607).

Subsequently, the local storage map update processing unit 116 updates the DL state of the local storage point cloud status 127 on the basis of the point cloud area/level information corresponding to the added point cloud information (step S11608). Specifically, the local storage map update processing unit 116 adds the element of the point cloud area/level information (X_{r_i}, Y_{r_i}, Z_{r_i}, LoD_{r_i}) added in step S11607 to the local storage point cloud status 127.

Then, the local storage map update processing unit 116 determines whether or not the individual requests for all the necessary data have been ended (step S11609). Specifically, the local storage map update processing unit 116 confirms a held value of i and determines whether or not i=s is satisfied. When i≠s is satisfied, the local storage map update processing unit 116 returns the processing to step S11605 and receives a next necessary data. Then, when i=s is satisfied, the local storage map update processing unit 116 determines that the individual requests for the necessary data have been ended, and advances the processing to the next step S11610.

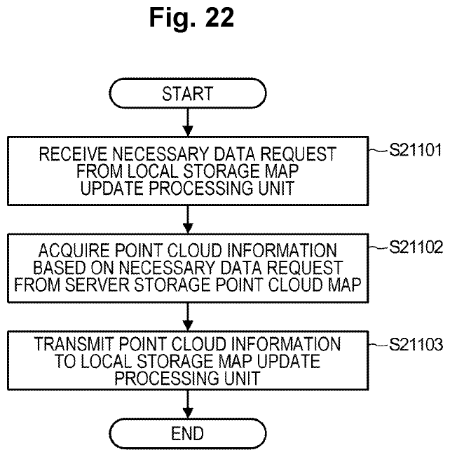

FIG. 22 is a flowchart illustrating an example of an operation processing procedure by the server point cloud data distribution processing unit 211 of the point cloud data distribution server 2. The processor of the point cloud data distribution server 2 can perform operation processing illustrated in the flowchart, for example, by executing a point cloud data distribution program stored in advance in the program memory. The operation processing illustrated in the flowchart is started as an independent thread at a time of executing the point cloud data distribution program, and is continuously executed in a loop by restarting after an end of the operation processing.

The server point cloud data distribution processing unit 211 receives the necessary data request from the local storage map update processing unit 116 of the viewing terminal 1 (step S21101). The necessary data request includes point cloud area/level information (X, Y, Z, LoD) that are space coordinates and LoD of the cubic space 31.

Subsequently, the server point cloud data distribution processing unit 211 acquires point cloud information based on the necessary data request received in step S21101 from the server storage point cloud map 231 (step S21102). Specifically, the server point cloud data distribution processing unit 211 acquires information matching the point cloud area/level information (X, Y, Z, LoD) included in the necessary data request from the server storage point cloud map 231. Information to be acquired is point cloud area/level information (X, Y, Z, LoD) of one cubic space of the server storage point cloud map 231 and all point cloud information (x_{point_1}, y_{point_1}, z_{point_1}, R₁, G₁, B₁), . . . included in the cubic space.

Then, the server point cloud data distribution processing unit 211 transmits the point cloud area/level information and all point cloud information acquired in step S21102 to the local storage map update processing unit 116 (step S21103). When the transmission is ended, the server point cloud data distribution processing unit 211 ends the operation processing procedure illustrated in the flowchart and starts the operation processing in step S21101 again.

As described above in detail, the point cloud data display device according to the first embodiment of the present invention includes the storage areas of the plurality of layers, the storage control unit, and the display unit. The storage areas of the plurality of layers are the local memory point cloud map 123, the local storage point cloud map 131, and the server storage point cloud map 231 that hierarchically store the point cloud information that is the 3D point cloud data measured for each of the cubic spaces 31 that are a plurality of continuous unit spaces such that the point cloud information included in the lower layer is included in the upper layer. The storage control unit is the local memory position monitoring processing unit 113, the local memory map update processing unit 114, the local storage position monitoring processing unit 115, and the local storage map update processing unit 116 that acquire and store, for each of the storage areas of the plurality of layers, minimum necessary point cloud information to be stored in the storage area of each layer from the storage area of the layer one layer lower. The display unit is the point cloud rendering processing unit 112 that reads the point cloud information stored in the storage area of the highest layer among the storage areas of the plurality of layers according to the viewpoint position and the line-of-sight direction of the user, and displays the point cloud information in the 3D VR space.

Thus, according to the point cloud data display device according to the first embodiment, a configuration is taken in which the storage area of the point cloud information included in each cubic space 31 is divided into a plurality of layers and hierarchized, and the minimum necessary point cloud information is obtained in each storage area layer from the viewpoint position and the line-of-sight direction of the user and acquired from the lower storage area layer, whereby it is possible to reduce an amount of operation of drawing, reduce the storage area necessary for data holding, and reduce communication delay. That is, the point cloud data display device according to the embodiment has a configuration of a multi-stage storage area, and selects and reads point cloud information necessary for drawing natural for the user on the basis of the viewpoint position and the line-of-sight direction. As a result, the large-scale 3D point cloud data on the point cloud data distribution server 2 can be downloaded and displayed at high speed by the viewing terminal 1 that is the client terminal. Thus, when the large-scale spatially high-resolution 3D point cloud data stored on the point cloud data distribution server 2 is viewed with the viewing terminal 1 via the network NW such as the Internet, it is possible to reduce the influence of the data acquisition time due to the restriction of the graphic processing capability of the viewing terminal 1 and the band and delay of the network NW not to impair viewing experience of the viewer.

In addition, the storage control unit performs acquisition of the point cloud information to the storage area by using different point cloud densities as the data structure in which the size of the amount of the point cloud information included in each cubic space 31 varies.

In this way, by defining the amount of data of the point cloud information included in each cubic space 31 with a plurality of levels and managing, acquiring, and storing the point cloud information with respect to the storage area of each layer, it is possible to further reduce the amount of operation of drawing, reduce the storage area necessary for data holding, and reduce the communication delay.

In addition, the storage control unit includes the viewpoint position acquisition processing unit 111, acquires the viewpoint position and the line-of-sight direction of the user from the viewpoint position controller 17, and determines the point cloud information to be acquired on the basis of the acquired current viewpoint position and line-of-sight direction.

As a result, for example, while the point cloud in the vicinity from the viewpoint position and the line-of-sight direction is kept dense, the number of points of the point cloud in the distance is reduced and made sparse, whereby the number of points handled in the graphics processing is reduced as compared with a case where calculation is performed on the entire 3D VR space with the dense point cloud, and as a result, the amount of calculation processing of the entire viewing terminal 1 can be reduced. In addition, it is possible to appropriately control the storage range and the storage location of the point cloud having the data structure expressed by a plurality of densities on the basis of the viewpoint position and the line-of-sight direction, and it is possible to solve the problem of exceeding the data area in the local storage point cloud map 131 and the local memory point cloud map 123 and the problem of increasing the time required to download the point cloud information from the server storage point cloud map 231.

Note that the server storage point cloud map 231 that is the storage area of the lowest layer among the storage areas of the plurality of layers is arranged on the point cloud data distribution server 2 that includes all point cloud information for all unit spaces and with which the storage control unit can communicate via the network NW.

As a result, the viewing terminal 1 does not need to store the all-point cloud information, and the storage capacity and the memory capacity can be reduced. In addition, the viewing terminal 1 can also reduce the amount of calculation of display calculation by reading the point cloud information with a narrow area and a low point cloud density within a range in which the viewing feeling is not greatly impaired, and accordingly, the ability required by the processor 11A can be suppressed. Thus, the viewing terminal 1 can be provided at low cost.

In this case, for the local memory point cloud map 123 that is a storage area other than a storage area of an upper layer one layer higher than the lowest layer among the storage areas of the plurality of layers, the storage control unit acquires all the minimum necessary point cloud information from the local storage point cloud map 131 that is a storage area of a layer one layer lower at a time. In addition, for the local storage point cloud map 131 that is a storage area of an upper layer one layer higher than the lowest layer, the storage control unit acquires the minimum necessary point cloud information for each cubic space 31 from the server storage point cloud map 231 that is a storage area of the lowest layer arranged on the point cloud data distribution server 2.

By doing this, point cloud information that will be required to be displayed in 3DVR most recently is read from the local storage point cloud map 131 to the local memory point cloud map 123 at a time, thereby being able to be displayed following a change in the viewpoint position and/or the line-of-sight direction of the viewer without delay. In addition, point cloud information that is not immediately necessary but may be necessary to be displayed in 3DVR can be downloaded in advance from the server storage point cloud map 231 to the local memory point cloud map 123 for each cubic space 31.

### Second Embodiment

In the first embodiment, the viewing terminal 1 is implemented by one computer. However, the viewing terminal 1 may be implemented by a plurality of computers.

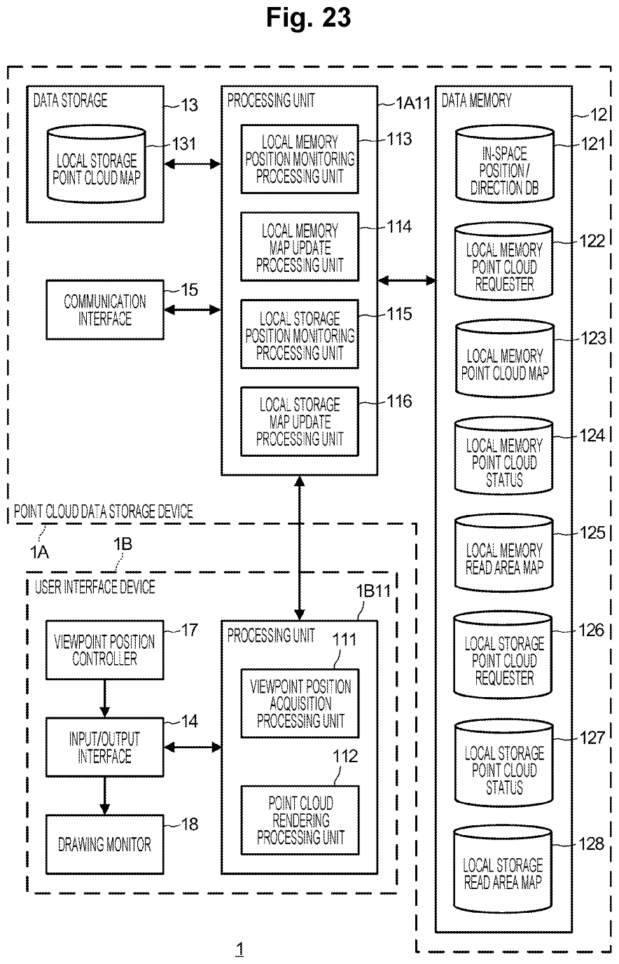

FIG. 23 is a block diagram illustrating a configuration example of the viewing terminal 1 in a point cloud data display device according to a second embodiment. As illustrated in FIG. 23, the viewing terminal 1 can be configured by two computers of a point cloud data storage device 1A and a user interface device 1B. For example, the point cloud data storage device 1A can include a processing unit 1A11 including the local memory position monitoring processing unit 113, the local memory map update processing unit 114, the local storage position monitoring processing unit 115, and the local storage map update processing unit 116, and the data memory 12, the data storage 13, and the communication interface 15 similar to those in the first embodiment. In addition, the user interface device 1B can include, for example, a processing unit 1B11 including the viewpoint position acquisition processing unit 111 and the point cloud rendering processing unit 112, and the input/output interface 14, the viewpoint position controller 17, and the drawing monitor 18 similar to those of the first embodiment. The processing unit 1A11 of the point cloud data storage device 1A and the processing unit 1B11 of the user interface device 1B can communicate information in a wired or wireless manner.

As described above, even when the viewing terminal 1 is configured by a plurality of computers, the viewing terminal 1 operates similarly to the first embodiment, and it is possible to obtain similar effects.

### Third Embodiment

In the first embodiment, the example has been described in which the point cloud information is stored in the storage areas of three layers of the server, the local storage, and the local memory, but the point cloud information may be stored in the storage areas of four or more layers. That is, it is possible to adopt a configuration of four or more layers by arranging any number of layers including: two processing units of a position monitoring processing unit that monitors the viewpoint position and the line-of-sight direction of the user, and a map update processing unit that updates point cloud information on a point cloud map; and four storage functions of a read area map that stores which point cloud area (cubic space 31) is to be read according to the viewpoint position and the line-of-sight direction of the user, a point cloud requester that holds a necessary point cloud area, a point cloud map that actually stores the point cloud information, and a point cloud status that manages the point cloud area of the point cloud information stored in the point cloud map. These layers to be added may be arranged in any of a preceding stage of the local storage, an intermediate stage between the local storage and the local memory, and a subsequent stage of the local memory.

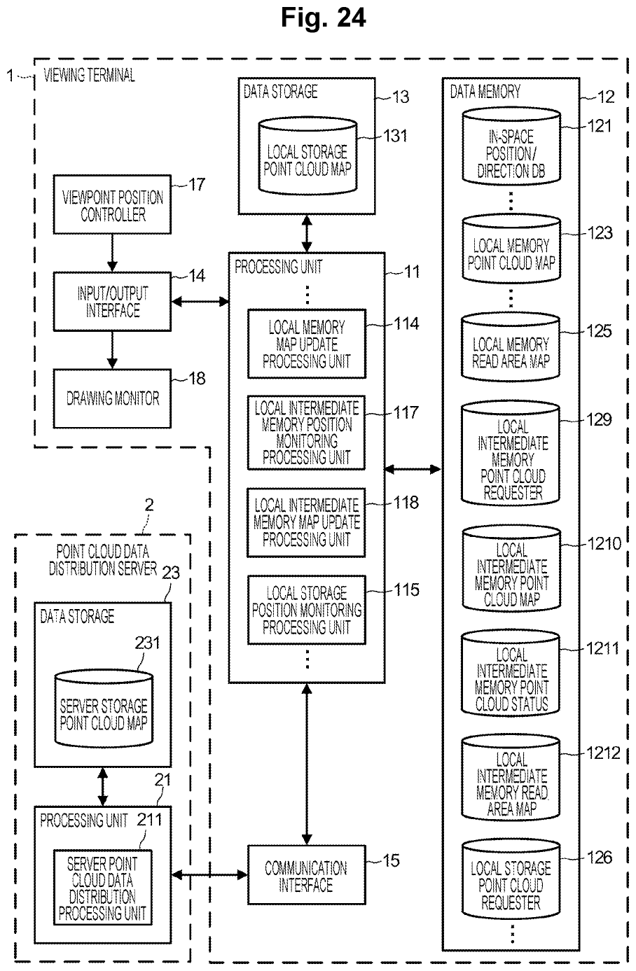

FIG. 24 is a block diagram illustrating a configuration example of the viewing terminal 1 and the point cloud data distribution server 2 in a point cloud data display device according to a third embodiment. FIG. 24 illustrates an example of a four-layer structure in which a layer of a local intermediate memory is provided between the local storage and the local memory. Note that, in FIG. 24, to simplify the drawing, the configurations of the processing unit 11 and the data memory 12 are partially omitted. In this case, the data memory 12 includes: a local intermediate memory read area map 1212 that stores a point cloud area (cubic space 31) that needs to be read according to the viewpoint position and the line-of-sight direction of the user; a local intermediate memory point cloud requester 129 that holds a necessary point cloud area; a local intermediate memory point cloud map 1210 that actually stores point cloud information; and a local intermediate memory point cloud status 1211 that manages a point cloud area of point cloud information stored in the local intermediate memory point cloud map 1210. In addition, the processing unit 11 includes: a local intermediate memory position monitoring processing unit 117 that monitors the viewpoint position and the line-of-sight direction of the user stored in the in-space position/direction DB 121; and a local intermediate memory map update processing unit 118 that updates the point cloud information of the local intermediate memory point cloud map 1210. In a case where the local intermediate memory layer is added in this way, the viewing terminal 1 handles four-level point cloud information including a point cloud density between LoD1 and LoD0.

Note that, in a case where a layer is added between the local storage and the local memory in this way, the local intermediate memory map update processing unit 118 performs an operation processing procedure in which the point cloud information in the storage area is acquired at a time and the status is updated, similarly to the local memory map update processing unit 114. However, in a case where the data acquisition time is long, similarly to the local storage map update processing unit 116, the local intermediate memory map update processing unit 118 may perform an operation procedure in which the point cloud information is acquired and updated one by one.

In addition, in a case where an additional layer is arranged at the subsequent stage of the local memory, the map update processing unit of the additional layer is set to perform an operation procedure in which the point cloud information is acquired and updated one by one, and the local storage map update processing unit 116 is set to perform an operation processing procedure in which the point cloud information in the storage area is acquired at a time and the status is updated. That is, only the map update processing unit of the last layer in which it is guaranteed that the data acquisition source has all point cloud information performs an operation procedure different from that of the other layers.

Even if expansion is performed to four or more layers in this way, effects similar to those of the first embodiment can be obtained.

Note that, it goes without saying that the expansion to four or more layers as in the third embodiment can be performed to the point cloud data storage device 1A of the point cloud data display device according to the second embodiment.

### Other Embodiments

Note that the present invention is not limited to the above-described embodiments.

For example, in the first to third embodiments, a range of data reading to the local memory point cloud map 123 and the local storage point cloud map 131 according to the viewpoint position 32 and the line-of-sight direction 33 is set by setting data onto the memory and the storage called the read area map data. However, instead of using such a memory, a storage, and setting data, a reading range may be geometrically specified. For example, the cubic space 31 included in a sphere having a fixed radius from the viewpoint position 32 is set as a reading target with LoD of a specified numerical value, a plurality of stages of LoD numerical values of the cubic space 31 to be read is set depending on the radius size, and the radius size is set in a wider range and a higher LoD in the local storage point cloud map 131 than in the local memory point cloud map 123, and the like. Another conceivable method is to define a cone that has the viewpoint position 32 as the apex and in which an extension line of the line-of-sight direction 33 passes through the center of a circle of the bottom surface, and to set a unit space included in the cone as a reading target with LoD of a specified numerical value. In the case of the cone, a plurality of stages of LoD numerical values of the unit space to be read may be set depending on the size of the bottom surface and/or the height of the cylinder, and the set values may be changed between the local storage and the local memory.

In addition, in the first to third embodiments, it is assumed that a point cloud of LoD0 is included in LoD1, and a point cloud of LoD1 is included in LoD2. However, in each LoD, an overlapping point cloud may not be included. In this case, for example, in a case where the local memory point cloud map 123 stores point cloud information with LoD0 for a certain point cloud area (the cubic space 31), when it is necessary to store point cloud information with LoD1 for the point cloud area, the point cloud information with LoD1 is acquired while the point cloud information with LoD0 is held. As a result, when LoD1 level point cloud information is displayed, point cloud information in both LoD0 and LoD1 can be displayed.

In addition, the flow of each of pieces of operation processing described with reference to the flowchart is not limited to the described procedure, and orders of some steps may be replaced, some steps may be performed simultaneously in parallel, or processing contents of some steps may be modified.

In addition, the method described in each embodiment can be stored as a processing program (software means) that can be executed by a computer in a recording medium such as a magnetic disk (Floppy (registered trademark) disk, hard disk, or the like), an optical disc (CD-ROM, DVD, MO, or the like), or a semiconductor memory (ROM, RAM, flash memory, or the like) or can be distributed by being transmitted through a communication medium. Note that the program stored on the medium side also includes a setting program for configuring, in the computer, the software means (including not only execution program but also table and data structure) to be executed by the computer. The computer that implements the present device executes the above-described processing by reading the programs recorded in the recording medium, constructing the software means by the setting program as needed, and controlling the operation by the software means. Note that the recording medium described in the present specification is not limited to a recording medium for distribution, but includes a storage medium such as a magnetic disk or a semiconductor memory provided in the computer or in a device connected via a network.

In short, the present invention is not limited to the above-described embodiments without any change and can be embodied by modifying the constituent elements within a range without departing from the gist of the present invention at the implementation stage. In addition, various inventions can be formed by appropriately combining a plurality of the constituent elements disclosed in the above embodiments. For example, some constituent elements may be omitted from all the constituent elements described in the embodiments. Further, constituent elements in different embodiments may be appropriately combined.

### REFERENCE SIGNS LIST

1 Viewing terminal
1A Point cloud data storage device
1B User interface device
2 Point cloud data distribution server
11A Processor
11B Program memory
11, 1A11, 1B11, 21 Processing unit
12 Data memory
13, 23 Data storage
14 Input/output interface
15 Communication interface
16 Bus
17 Viewpoint position controller
18 Drawing monitor
31 Cubic space
32 Viewpoint position
33 Line-of-sight direction
34 Drawing screen
35 Point in 3D VR space
36 Projection point
37 Intersection of viewpoint camera coordinate system and screen coordinate system
111 Viewpoint position acquisition processing unit
112 Point cloud rendering processing unit
113 Local memory position monitoring processing unit
114 Local memory map update processing unit
115 Local storage position monitoring processing unit
116 Local storage map update processing unit
117 Local intermediate memory position monitoring processing unit
118 Local intermediate memory map update processing unit
121 In-space position/direction DB
122 Local memory point cloud requester
123 Local memory point cloud map
124 Local memory point cloud status
125 Local memory read area map
126 Local storage point cloud requester
127 Local storage point cloud status
128 Local storage read area map
129 Local intermediate memory point cloud requester
1210 Local intermediate memory point cloud map
1211 Local intermediate memory point cloud status
1212 Local intermediate memory read area map
131 Local storage point cloud map
211 Server point cloud data distribution processing unit
231 Server storage point cloud map
NW Network

1. A point cloud data display device comprising:
storage areas of a plurality of layers configured to hierarchically store three-dimensional (3D) point cloud data measured for each of a plurality of continuous unit spaces such that 3D point cloud data included in a lower layer is included in an upper layer;
a storage control unit configured to acquire, for each of the storage areas of the plurality of layers, minimum necessary 3D point cloud data to be stored in a storage area of each layer from a storage area of a layer one layer lower, and cause the minimum necessary 3D point cloud data to be stored; and
a display unit configured to read the 3D point cloud data stored in a storage area of a highest layer among the storage areas of the plurality of layers according to a viewpoint position and a line-of-sight direction of a user, and display the 3D point cloud data in a 3D virtual reality space.

2. The point cloud data display device according to claim 1, wherein the storage control unit is configured to perform acquisition of the 3D point cloud data to the storage areas by using a data structure in which a size of an amount of data of the 3D point cloud data included in each unit space varies.

3. The point cloud data display device according to claim 1, wherein the storage control unit is configured to determine the 3D point cloud data to be acquired on a basis of the viewpoint position and the line-of-sight direction of the user.

4. The point cloud data display device according to claim 1, wherein a storage area of a lowest layer among the storage areas of the plurality of layers includes all of the 3D point cloud data for all the unit spaces, and is arranged on a server with which the storage control unit is enabled to communicate via a network.

5. The point cloud data display device according to claim 4, wherein
the storage control unit is configured to:
acquire all of the minimum necessary 3D point cloud data from the storage area of the layer one layer lower at a time for the storage areas other than a storage area of an upper layer one layer higher than the lowest layer among the storage areas of the plurality of layers, and
acquire the minimum necessary 3D point cloud data for each of the unit spaces from the storage area of the lowest layer arranged on the server for the storage area of the upper layer one layer higher than the lowest layer.

6. A point cloud data storage device comprising:
storage areas of a plurality of layers configured to hierarchically store three-dimensional (3D) point cloud data measured for each of a plurality of continuous unit spaces such that 3D point cloud data included in a lower layer is included in an upper layer; and
a storage control unit configured to acquire, for each of the storage areas of the plurality of layers, minimum necessary 3D point cloud data to be stored in a storage area of each layer from a storage area of a layer one layer lower, and cause the minimum necessary 3D point cloud data to be stored.

7. A point cloud data display method in a point cloud data display device configured to display three-dimensional (3D) point cloud data according to a viewpoint position and a line-of-sight direction of a user in a three-dimensional virtual reality space,
the point cloud data display method comprising:
hierarchically storing the 3D point cloud data measured for each of a plurality of continuous unit spaces in storage areas of a plurality of layers such that the 3D point cloud data included in a lower layer is included in an upper layer;
acquiring, for each of the storage areas of the plurality of layers, minimum necessary 3D point cloud data to be stored in a storage area of each layer from a storage area of a layer one layer lower, and causing the minimum necessary 3D point cloud data to be stored; and
reading the 3D point cloud data stored in a storage area of a highest layer among the storage areas of the plurality of layers according to a viewpoint position and a line-of-sight direction of a user, and displaying the 3D point cloud data in a 3D virtual reality space.

8. A non-transitory computer readable medium storing a program, wherein execution of the program causes a computer to function as the point cloud data display device according to claim 1.
